(19) United States
(12) Patent Application Publication
(10) Pub. No.: US 2014/0142961 A1
(43) Pub. Date: May 22, 2014

(54) MANAGING RESEARCH DATA FOR CLINICAL DRUG TRIALS

(71) Applicants: Mike Luter, San Antonio, TX (US); Theresa Mays Hutchings, San Antonio, TX (US); Leslie Smetzer, San Antonio, TX (US); Anthony William Tolcher, Shavano Park, TX (US)

(72) Inventors: Mike Luter, San Antonio, TX (US); Theresa Mays Hutchings, San Antonio, TX (US); Leslie Smetzer, San Antonio, TX (US); Anthony William Tolcher, Shavano Park, TX (US)

(21) Appl. No.: 13/699,555

(22) PCT Filed: May 27, 2011
(86) PCT No.: PCT/US11/38426

§ 371 Date: Jan. 24, 2014

Related U.S. Application Data
(60) Provisional application No. 61/349,562, filed on May 28, 2010.

(51) Int. Cl. G06F 19/00

(52) U.S. Cl. CPC G06F 19/366
USPC 705/2

(57) ABSTRACT

A machine, computer program product, and computer-implemented method for performing a process of managing clinical research data by collating a plurality of clinical patient records into a database system and a process of allowing particular clinical users to access the clinical research records.

This application is a continuation of and claims priority to U.S. Provisional Application 61/349,562 titled “Machine, Computer Program Product, and Computer Implemented Method for Managing Clinical Research Data for a Plurality of Clinical Patients Participating in Clinical Drug Studies” filed on May 28, 2010, which is incorporated herein in its entirety.

### BACKGROUND

1. Field of the Invention

The invention relates generally to a database for managing a plurality of clinical research data and more specifically to a database that manages a plurality of clinical patient records for a plurality of clinical patients participating in a plurality of different clinical oncology drug studies, the plurality of patient records for each oncology clinical drug study only being accessible to a plurality of clinical users associated with the oncology clinical drug study.

2. Prior Art

Currently, the vast majority of clinical research data from clinical research studies performed in clinical patients receiving medical care for oncology is obtained from a number of diverse modalities: paper clinical research records, electronic clinical research records, laboratory results (paper or digital), electrocardiograms and radiologic images and hand entered by data managers into paper case report forms or key entered by data managers into electronic data capture systems. The data is anonymized by the data managers at the site for the protection of research subject's privacy. This source data is then monitored infrequently (customarily monthly) by the study clinical sponsor, or their representative, to verify the data entered from a source as well as to correct transcription errors associated with hand or key entered data. The clinical sponsor can then review the verified data from the electronic data capture system, make decisions regarding the safety of the investigational agent or treatment, and furthermore make decisions regarding dose escalation, continuation of the clinical study, or possible indications for future development. These multiple steps delay significantly the time between data collection at the site and review and decision making by the study clinical sponsor, and contributes, in part, to the slow pace of clinical research in cancer medicine.

### SUMMARY OF THE INVENTION

A machine, computer program product, and computer-implemented method for performing a process of managing clinical research data by collating a plurality of clinical research records for a plurality of clinical patients into a database system and a process of allowing particular clinical users to access the clinical research records is described herein. A portal database according to embodiments of the invention is an innovative data transfer program that permits the movement, organization, compilation and anonymization of clinical research records onto the web so that pharmaceutical research clinical sponsors can assess safety data for new pharmaceutical agents in clinical studies in real-time.

Ideally, the portal database software is agnostic to the different modalities used to collect clinical research records. Both objective data including vital signs, laboratory results (complete blood counts (CBC), clinical chemistry, tumor markers, etc), digital electrocardiographic data and QTC waveforms derived from digital twelve-lead electrocardiogram (EKG), imaging data derived from archiving systems as well as subjective data obtained by the physician at the bedside or clinic and categorized according to the National Cancer Institute common toxicity criteria is NCI-CTC anonymized, collated, assembled for display in a chronologic order and coded to permit clinical sponsors from seeing only the data from their particular clinical study, and not other clinical sponsors during and exclusively for the period they are designated as sponsor clinical users for the clinical study. These clinical research records are then made available in chronological fashion on the website daily such that all key safety data is available for viewing and reviewing, analysis and real-time decision-making. This immediate access to data accelerates the time to decision, and increases the transparency of clinical trial data, which will improve oversight and drug safety.

To implement the following objectives, the invention consists of a machine, computer program product, and computer-implemented methods. A machine for allowing a plurality of clinical users to access a clinical research records database, the machine comprising: a first database storing clinical patient exam records, the first database receiving inputs from a plurality of medical care providers, the inputs including clinical patient vital signs; a second database storing lab clinical reports from a medical laboratory, the lab clinical reports including urine analysis, blood analysis, chemical lab tests, and toxology information; a third database storing radiological data received from a radiologist, the radiology data including MRIs, CT scans and PET scans; a fourth database storing EKG data received from a plurality of heart monitoring devices including, for example, an EKG machine and an echocardiogram machine; and a computer, defining a portal database, the portal database being connected to each of the first database, the second database, the third database and the fourth database, the portal database having a non-transitory computer memory with a computer program product stored thereon and operable on the portal database, the computer program product performing a process of organizing the clinical research records into a database system and a process of allowing particular clinical users to access the clinical research records, the computer program executing the operations of: populating a plurality of clinical study database tables, the clinical study database tables including, a name of a clinical study sponsor; a name of a clinical drug study associated with the clinical sponsor, one or more clinical patient identifiers associated with the clinical drug study, each of the plurality of patient identifiers being linked to clinical patient records for a patient associated with each of the plurality of patient identifiers, and clinical users associated with the clinical drug study, the clinical users having permissions, the permissions including a permission to add data to the clinical research records, a permission to view the clinical research records, a permission to print the clinical research records, and a permission to edit the clinical drug study tables, creating a record request prompt, responsive to the clinical user requesting access to a clinical drug study, the record request prompt being associated with each clinical drug study and being organized by a clinical drug study enrollment date for each of the one or more clinical patients identified by the clinical patient identifiers, linking, responsive to a clinical user request for a particular clinical patient record on the record request prompt, the clinical research records for the particular clinical patient from the portal database so as to allow the clinical user to view all available clinical research records related to the clinical drug study associated with the particular clinical patient record, the clinical research records being organized by record type for selection by the clinical user, and formatting, responsive to the selection of a clinical research record by the clinical user, the clinical research record for display on the portal database to the clinical user.

An embodiment of the machine wherein the clinical patient identifiers are generated by a clinical patient add wizard, the clinical patient add wizard comprising prompts that allow the clinical user to enter at least one of a particular clinical patient's clinical research record number, a particular clinical patients clinical sponsor identification number, the clinical drug study and the name of the clinical drug study clinical sponsor is also described herein. An embodiment of the machine wherein the permissions template is generated by a personnel management wizard, the personnel management wizard being controlled by a administrative clinical user, the administrative clinical user being prompted to enter at least one of the following, a clinical user name, a research institution, pharmaceutical company or outside service provider associated with the clinical user, an address of the research institution, pharmaceutical company or outside service provider, and a password and unique clinical user name associated with the clinical user may also be implemented. In such an embodiment, the personnel management wizard identifies each of the clinical users by the clinical user's role in the clinical drug study, the clinical user's role being selected from a group comprising study clinical user, preclinical study clinical user, sponsor clinical user, administrator clinical user, and program clinical user. In some embodiments, a complete report of the clinical research records associated with the particular clinical patient can be accessed by the clinical user or a particular clinical research record can be accessed. In some embodiments, the clinical research records include a complete blood count, a clinical chemistry, a clinical patient report, summary report, a vital signs report, an adverse events report, a toxicity report and a urine report. In some embodiments, the record request prompt further includes an indication of whether the particular clinical patient has a tumor present and whether the clinical drug study has ended.

In some embodiments, the machine includes a quality assurance prompt with each clinical study, the quality assurance prompt including at least some of a particular institution, pharmaceutical company or outside service provider, entering clinical research records into the database, the clinical drug study associated with the clinical research records, the clinical user that entered the clinical research records, the number of particular clinical patients having clinical research records entered into the machine by the clinical user in a particular session, the clinical patient identifier for the clinical research records, and the type of clinical research records entered. In some embodiments, the quality assurance prompt may also include a listing of the most active clinical users of the machine for a particular clinical study in a particular time period.

A computer program product stored on a non-transitory computer memory and operable on a computer defining a portal database, the computer program product performing a process of organizing the clinical research records into a database system and a process of allowing particular clinical users to access the clinical research records, the computer program executing the operations of: populating a plurality of clinical study database tables, the clinical study database tables including, a name of a clinical study sponsor; a name of a clinical drug study associated with the clinical sponsor, one or more clinical patient identifiers associated with the clinical drug study, each of the plurality of patient identifiers being linked to clinical patient records for a patient associated with each of the plurality of patient identifiers, and clinical users associated with the clinical drug study, the clinical users having permissions, the permissions including a permission to add data to the clinical research records, a permission to view the clinical research records, a permission to print the clinical research records, and a permission to edit the clinical drug study tables, creating a record request prompt, responsive to the clinical user requesting access to a clinical drug study, the record request prompt being associated with each clinical drug study and being organized by a clinical drug study enrollment date for each of the one or more clinical patients identified by the clinical patient identifiers, linking, responsive to a clinical user request for a particular clinical patient record on the record request prompt, the clinical research records for the particular clinical patient from the portal database so as to allow the clinical user to view all available clinical research records related to the clinical drug study associated with the particular clinical patient record, the clinical research records being organized by record type for selection by the clinical user, and formatting, responsive to the selection of a clinical research record by the clinical user, the clinical research record for display on the portal database to the clinical user.

A computer-implemented method comprising instructions that cause a computer to perform a process of organizing the clinical research records into a database system and a process of allowing particular clinical users to access the clinical research records, the computer-implemented method executing the operations of: populating a plurality of clinical study database tables, the clinical study database tables including, a name of a clinical study sponsor; a name of a clinical drug study associated with the clinical sponsor, one or more clinical patient identifiers associated with the clinical drug study, each of the plurality of patient identifiers being linked to clinical patient records for a patient associated with each of the plurality of patient identifiers, and clinical users associated with the clinical drug study, the clinical users having permissions, the permissions including a permission to add data to the clinical research records, a permission to view the clinical research records, a permission to print the clinical research records, and a permission to edit the clinical drug study tables, creating a record request prompt, responsive to the clinical user requesting access to a clinical drug study, the record request prompt being associated with each clinical drug study and being organized by a clinical drug study enrollment date for each of the one or more clinical patients identified by the clinical patient identifiers, linking, responsive to a clinical user request for a particular clinical patient record on the record request prompt, the clinical research records for the particular clinical patient from the portal database so as to allow the clinical user to view all available clinical research records related to the clinical drug study associated with the particular clinical patient record, the clinical research records being organized by record type for selection by the clinical user, and formatting, responsive to the selection of a clinical research record by the clinical user, the clinical research record for display on the portal database to the clinical user.

### BRIEF DESCRIPTION OF THE DRAWINGS

So that the manner in which the features and advantages of the invention, as well as others, which will become apparent, may be understood in more detail, a more particular description of the invention briefly summarized above may be had by reference to the embodiments thereof, which are illustrated in the appended drawings, which form a part of this specification. It is to be noted, however, that the drawings illustrate only various embodiments of the invention and are therefore not to be considered limiting of the invention's scope as it may include other effective embodiments as well.

FIG. 1 is a network diagram of a clinical data machine having several clinical databases and clinical users interacting thereon according to an embodiment of the invention;

FIG. 2A is a block diagram of a portal database computer for providing access to the several clinical databases and allowing clinical users to interact thereon according to an embodiment of the invention;

FIG. 2B is a block diagram of a portal database computer for providing access to several clinical databases and allowing clinical users to interact thereon, the portal database computer having a program product thereon with instructions according to an embodiment of the invention;

FIG. 3A is a flow diagram for a computer program product stored on a portal database for providing access to several clinical databases and allowing clinical users to interact thereon according to another embodiment of the invention;

FIG. 3B is a continuation of the flow diagram of FIG. 3A for a computer program product stored on a portal database for providing access to several clinical databases and allowing clinical users to interact thereon according to another embodiment of the invention;

FIG. 4A is a decision tree diagram for a set of instructions for a computer program product stored on a portal database for verifying a clinical user and allowing the clinical user access to a portion of the portal database according to an embodiment of the invention.

FIG. 4B is a decision tree diagram for the updating of patient clinical data in the portal database according to an embodiment of the invention;

FIG. 5A is a flow diagram for populating and updating a clinical database stored in a memory of a computer, the flow diagram showing instruction for populating and updating clinical sponsor tables, clinical study tables, clinical user tables, and clinical patient tables according to an embodiment of the invention.

FIG. 5B is a clinical database diagram for data stored in a memory of a computer, the clinical database having clinical sponsor record data, clinical study data, clinical patient data, clinical sponsor data, clinical user data and clinical user address and permission data according to an embodiment of the invention;

FIG. 6 is a computer display page of a portal database log in page having data entry selection fields for a user name and a user password according to an embodiment of the invention;

FIG. 7 is a computer display page of a portal database password change login screen, the password login screen having data entry points for changing a password and having a password emailed to a clinical user according to an embodiment of the invention;

FIG. 8 is a computer display page showing a portal database clinical study selection page allowing a clinical user to select a study for viewing reports and study data according to the clinical user's access permissions according to an embodiment of the invention;

FIG. 9 is a computer display page showing various clinical reports that may be available for a clinical user to view for a particular selected clinical patient from the selected study according to an embodiment of the instant invention;

FIGS. 10A and 10B are computer display pages showing a clinical summary report for a particular clinical patient, the clinical summary report including a clinical chemistry report and a vitals report for a particular patient associated with a selected study according to an embodiment of the instant invention;

FIG. 11 is a computer display page showing a CBC (hematology) record for a particular patient associated with a selected study, the display page being initiated when the clinical user selects such report for viewing according to an embodiment of the instant invention;

FIG. 12 is a computer display page showing a clinical chemistry record for a particular patient associated with a selected study, the display page being initiated when the clinical user selects such report for viewing according to an embodiment of the instant invention;

FIG. 13 is a computer display page showing a urine record for a particular patient associated with a selected study, the display page being initiated when the clinical user selects such report for viewing according to an embodiment of the instant invention;

FIG. 14 is a computer display page showing a toxicity grading statistics record for a particular patient associated with a selected study, the display page being initiated when the clinical user selects such report for viewing according to an embodiment of the instant invention;

FIG. 15 is a computer display page showing an adverse events record for a particular patient associated with a selected study, the display page being initiated when the clinical user selects such report for viewing according to an embodiment of the instant invention;

FIG. 16 is a computer display page showing a radiology image for a particular patient associated with a selected study, the display page being initiated when the clinical user selects such image for viewing according to an embodiment of the instant invention;

FIG. 17A is a computer display page of a list of heart EKG or electrocardiogram for a particular patient associated with a selected study, the display page being initiated when the clinical user selects such report for viewing according to an embodiment of the instant invention;

FIG. 17B is a computer display page of an EKG record for a particular patient associated with a selected study, the display page being initiated when the clinical user selects such report for viewing according to an embodiment of the instant invention;

FIG. 18 is a computer display page showing a clinical user profile form having a clinical user name entry tab, clinical user address tab, a change password tab, and an other tab, the clinical user profile form being initiated upon the selection of profile, according to an embodiment of the instant invention;

FIG. 19 is a computer display page showing a configuration menu initiated upon the selection of configuration from an administrative menu, the configuration menu allowing an administrative clinical user to add sponsors, studies, patients, and users to the system, according to an embodiment of the instant invention;

FIG. 20A is a computer display page showing a clinical sponsor add wizard initiated upon the selection of clinical sponsor add from a configuration menu, the clinical sponsor add wizard allowing the administrative user to add a clinical sponsor to the system, according to an embodiment of the instant invention;

FIG. 20B is a computer display page showing a clinical sponsor edit wizard initiated upon the selection of clinical sponsor edit from a configuration menu and allowing an administrative clinical user to edit clinical sponsor data in the system, according to an embodiment of the invention;

FIG. 21A is a computer display page showing a clinical study add wizard initiated upon the selection of clinical study add from a configuration menu, the clinical study add wizard allowing the administrative user to add a clinical study to the system, according to an embodiment of the instant invention;

FIG. 21B is a computer display page showing a clinical study edit wizard initiated upon the selection of clinical study edit from a configuration menu and allowing an administrative clinical user to edit clinical study data in the system, according to an embodiment of the invention;

FIG. 22A is a computer display page showing a clinical patient add wizard initiated upon the selection of clinical patient add from a configuration menu, the clinical patient add wizard allowing the administrative user to add a clinical study to the system, according to an embodiment of the instant invention;

FIG. 22B is a computer display page showing a clinical patient edit wizard initiated upon the selection of clinical patient edit from a configuration menu and allowing an administrative clinical user to edit clinical patient data in the system, according to an embodiment of the invention;

FIG. 23 is a computer display page showing a clinical user edit wizard initiated upon the selection of clinical user edit from a configuration menu, the clinical user add wizard allowing the administrative user to add a clinical user to the system, according to an embodiment of the instant invention;

FIG. 24A is a computer display page showing a personnel management menu initiated upon the selection of clinical user edit from the configuration menu and allowing an administrative clinical user to edit clinical patient data in the system, according to an embodiment of the instant invention;

FIG. 24B is a computer display page showing a clinical study access tab selected from the personnel management menu, the clinical study access tab for editing studies a clinical user can access according to an embodiment of the instant invention;

FIG. 24C is a computer display page showing a clinical roles tab selected from the personnel management menu, the clinical roles tab for editing a selected clinical users access to clinical study data according to an embodiment of the instant invention;

FIG. 25A is a computer display page showing a clinical reports maintenance menu initiated upon the selection of clinical reports from an administration menu, the clinical reports maintenance menu allowing a user to select which report histories the clinical user would like to see, according to an embodiment of the instant invention;

FIG. 25B is a computer display page showing a download history for various clinical reports selected in the clinical reports maintenance menu according to an embodiment of the instant invention;

FIG. 25C is a computer display page showing a quality assurance report showing the clinical users that have accessed reports for a particular study, and an assurance response clinical user that has logged into the report according to an embodiment of the invention;

FIG. 26 is a computer display page showing an email selection initiated upon the selection of email from an administration menu according to an embodiment of the invention;

### DETAILED DESCRIPTION

The present invention will now be described more fully hereinafter with reference to the accompanying drawings in which embodiments of the invention are shown. This invention may, however, be embodied in many different forms and should not be construed as limited to the illustrated embodiments set forth herein; rather, these embodiments are provided so that this disclosure will be thorough and complete, and will fully convey the scope of the invention to those skilled in the art.

It is an object of the invention to provide a machine, program product and computer-implemented method that are capable of managing a plurality of clinical patient records. It is a further object of the invention to provide a machine, program product and computer-implemented method that is capable of automatically updating a portal database with new clinical patient records for so that the most current clinical patient data can be observed by clinical users, including clinical sponsor users, i.e., drug companies, and clinical internal users, i.e., researchers. It is a further object of the invention that a machine, program product and computer-implemented method allow secured access only to clinical sponsor users associated with a particular clinical drug study, i.e., the drug study that is being sponsored by the drug company associated with the clinical sponsor user, but allow clinical internal users access to a plurality of drug studies associated with a plurality of drug company sponsors. Finally, it is an object of the invention to provide a single portal for access by multiple sponsor clinical users so that the sponsor clinical users can verify clinical research data and make determinations regarding the future of the clinical study, efficacy of the drug, etc. As one skilled in the art will appreciate, though the term clinical is used through-out the specification, drawings and claims, the term clinical as referenced herein can refer to any phase or type of drug study including preclinical or clinical studies, studies in author review, etc.

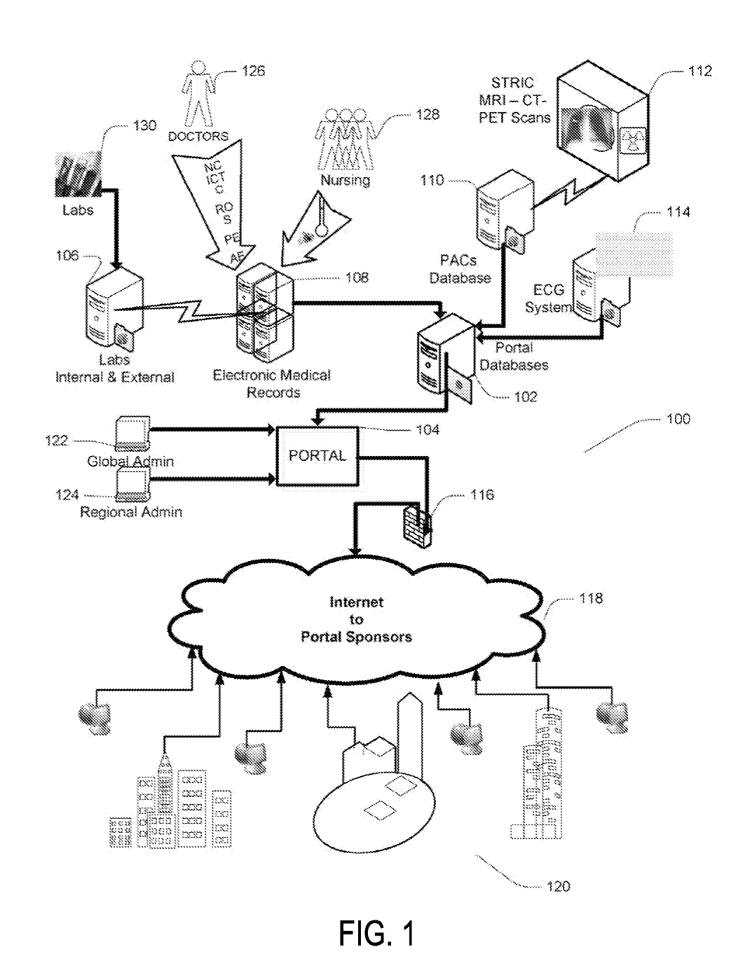

A machine for achieving the objectives noted above and for managing a plurality of clinical research records for a plurality of clinical patients participating in drug studies is described herein with reference to FIG. 1. A machine comprises a portal database 102 running a computer program product 104, an internal and external labs database 106 connected to an electronic clinical research records database 108, a PACs database 110 connected to a MRI, PET and CT scan machine 112, and an EKG database 114. The portal database 102 can comprise a web server (not shown) and fire wall 116, to connect the portal database to a communications network, e.g., the internet 118 and various external institutions 120, e.g., drug companies. Together, the portal database, internal and external labs database and electronic clinical research records database, PAC database, EKG database and communications network provide a platform for researchers and clinical sponsors to view, collaborate and review consolidated clinical study records for a particular drug, while limiting access to a particular clinical study to only certain clinical users.

Communications network 118, which can be e.g., a combination of the internet and intranet, allow a plurality of clinical users to access the clinical research records data, such clinical users include external clinical users 120, e.g., drug companies, and global and administrative clinical users 122 and 124, respectively, and may also connect the various components of the machine. As such, communications network 118 can connect all of the system components using a local area network (“LAN”) or wide area network (“WAN”), or a combination thereof. For example, portal database 102, electronic clinical research records database 108 and external and internal labs database 106, PAC database 110, EKG database 114, may be privately networked to allow for security, faster communication and better data synchronization, or portal database 102, electronic clinical research records database 108 and external and internal labs database 106, PAC database 110, EKG database 114, may be networked using a LAN, with a web server (not shown) interfacing with external clinical users using a WAN. Moreover, global and regional administrative clinical users may be able to interact with the portal database via a LAN or WAN type connection. Accordingly, though not all such configurations are depicted in the drawings, all are within the scope of the disclosure.

Preferably, the communications network 118 works in conjunction with firewall 116 to provide a secure access point for external clinical users 120 and prevent non-authorized external clinical users from accessing the various databases of the machine, e.g., between the LAN and WAN connections. The firewall 116 may be a network layer firewall i.e., packet filters, application level firewalls, or proxy servers. As one skilled in the art knows, packet filters do not allowing packets to pass through the firewall unless they match an established rule set, which may be defined by the global administrator 122 or regional administrator 124. In other words, a packet filter firewall can be used to block traffic from particular source IP addresses, source ports, destination IP addresses or ports, or destination service like www or FTP, though a packet filter in this instance would most likely block certain source IP addresses. An application layer firewall may intercept all packets traveling to or from the portal database, and may be used to prevent unauthorized clinical users from reaching protected machines. Finally, a proxy server may also act as a firewall by responding to some input packets and blocking other packets. While each of these firewalls can be used in the machine of the invention, preferably a CISCO hardware firewall is used.

As shown, a plurality of file servers, indirectly connected to the firewall 116, are employed by the machine as a electronic clinical research records database 108 and external and internal labs database 106, PAC database 110, and EKG database 114, and portal database 102, and each file server communicates with and uploads data to the portal database. Each of these file servers may be network attached storage (NAS), storage area networks (SAN), or direct access storage (DAS), or any combination thereof, comprising, e.g., multiple hard disk drives. The file servers defining the electronic clinical research records database 108 and external and internal labs database 106, PAC database 110, EKG database 114 may also allow various clinical user workstations (not shown) to directly access, and display data stored thereon. Moreover, each of the file servers may allow clinical users to upload data to each of the electronic clinical research records database 108 and external and internal labs database 106, PAC database 110, EKG database 114. For example, labs 126 may be uploaded to the internal and external labs database, by e.g., a pathologist; doctors 128 and nurses 130 may upload vital sign and other exam data and notes to the electronic clinical research records database 108; PET scans, MRI scans and CT scans may be uploaded to the PAC database by, e.g., a radiologist or radiology technician; EKG, electrocardiogram, or other data from heart monitors may be entered into the EKG database by e.g., a cardiologist. Accordingly, as is known in the art, each file server may have stored thereon database management system, e.g. a set of software programs that controls the organization, storage, management, and retrieval of data in the databases.

Electronic clinical research records database 108 and external and internal labs database 106, PAC database 110, EKG database 114, and any other databases, may be separate databases on separate file servers as shown, or two ore more databases can exist on the same file server, and data can be stored in each server as a plurality of databases, tables, or fields in separate portions of the file server memory. As one skilled in the art will appreciate, the file servers provide the portal database 102 access to the electronic clinical research records database 108 and external and internal labs database 106, PAC database 110, EKG database 114 through, e.g., database management software or other application. Moreover, one or more database servers may be used to store the databases instead of or in addition to file servers and such a configuration is within the scope of this disclosure.

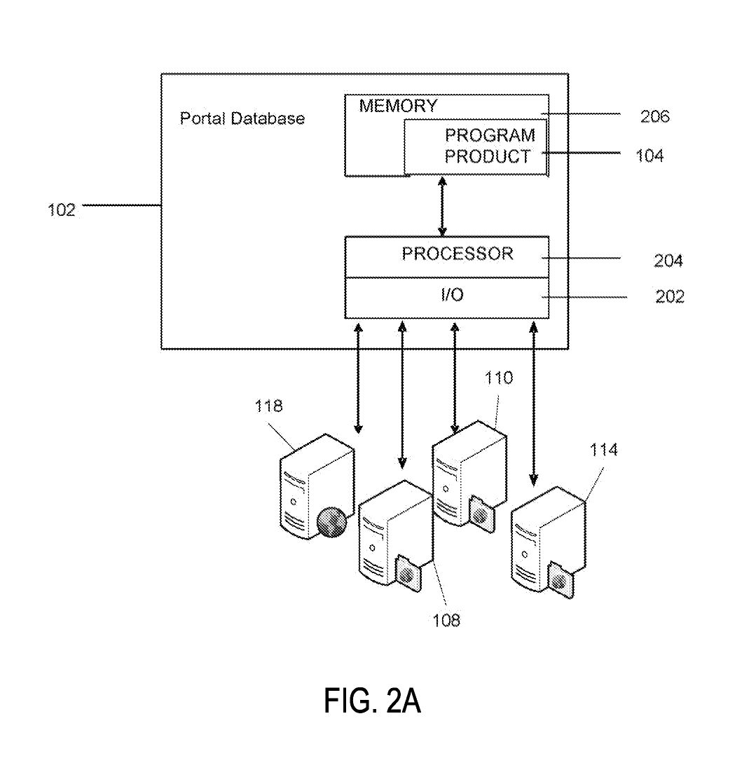

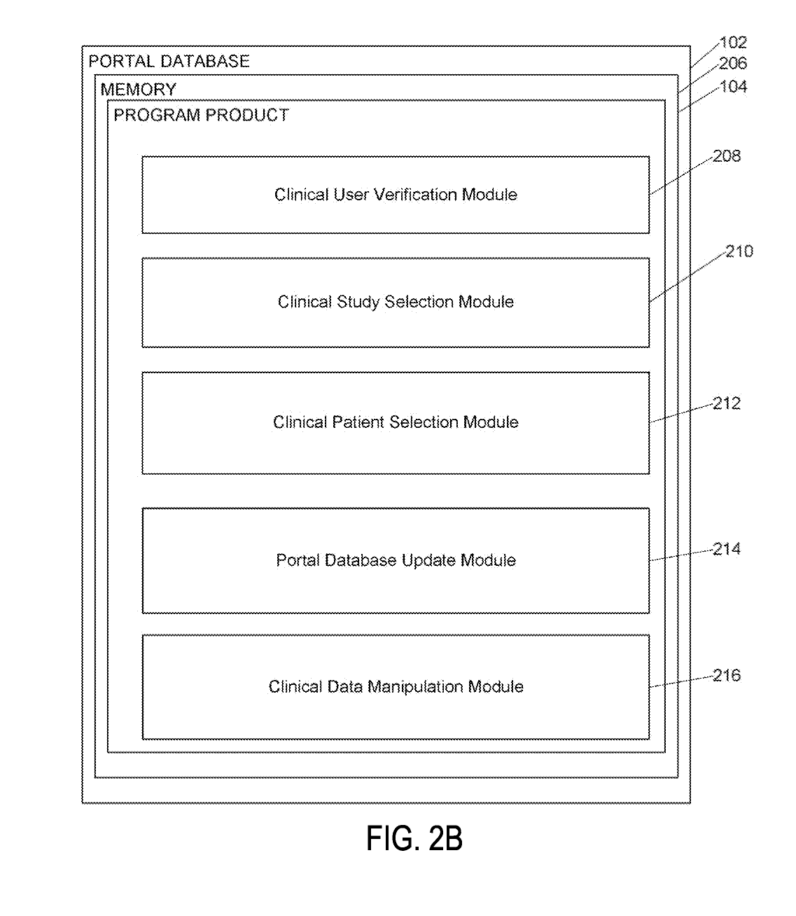

A portal database 102 and will now be described with reference to FIGS. 2A and 2B. A file server, defining a portal database 102, comprises a memory 206, a program product 208 a processor 204 and an input/output device (“I/O device”) 202. I/O device 202 connects the portal database 102 to a signal output from the first inverter, and can be any I/O device including, but not limited to a network card/controller connected by a PCI bus to the motherboard, or hardware built into the motherboard to connect the portal database 102 to the various file servers defining the electronic clinical research records database 108 and external and internal labs database 106, PAC database 110, EKG database 114 and communication network 118.

As can be seen, the I/O device 202 is connected to the processor 204. Processor 204 is the “brains” of the portal database 102, and as such executes program product 208 and works in conjunction with the I/O device 202 to direct data to memory 206 and to send data from memory 206 to the various file servers and communications network. Processor 204 can be, e.g., any commercially available processor, or plurality of processors, adapted for use in an portal database 102, e.g., Intel® Xeon® multicore processors, Intel® micro-architecture Nehalem, AMD Opteron™ multicore processors, etc. As one skilled in the art will appreciate, processor 204 may also include components that allow the portal database 102 to be connected to a display [not shown] and keyboard that would allow, for example, an administrative user direct access to the processor 204 and memory 206.

Memory 206 may store the algorithms forming the computer program product of the instant invention and data, and such, memory 206 may consists of both non-volatile memory, e.g., hard disks, flash memory, optical disks, and the like, and volatile memory, e.g., SRAM, DRAM, SDRAM, etc., as required by embodiments of the instant invention. As one skilled in the art will appreciate, though memory 206 is depicted on, e.g., the motherboard, of the portal database 102, memory 206 may also be a separate component or device, e.g., FLASH memory, connected to the portal database 102.

The program product of the instant invention has several clinical user modules as shown in FIG. 2B. A first module defines a clinical user verification module 208 for providing access to the database and determining system permissions for a valid clinical user. A second module defines a clinical study selection 210 module for populating a clinical study selection menu with a plurality of clinical studies associated with the clinical user and allowing a clinical user to select a clinical study; a third module defines a clinical patient selection module 212 for populating a clinical patient selection menu with clinical patient records associated with the selected clinical study to allow a clinical user to select a clinical patient and populating a clinical data report menu for allowing a clinical user to select a clinical report. A fourth module defines a portal database update module 214 for allowing an administrative clinical user to update clinical user, clinical patient and clinical sponsor records and for polling the electronic clinical research records database, external and internal labs database, PAC database, and EKG database to update clinical patient records. A fifth module defines a clinical data manipulation module 216, and may allow a clinical user to leave notes for a particular clinical study or clinical patient, email notes and clinical reports to other clinical users associated with a clinical study and print clinical reports.

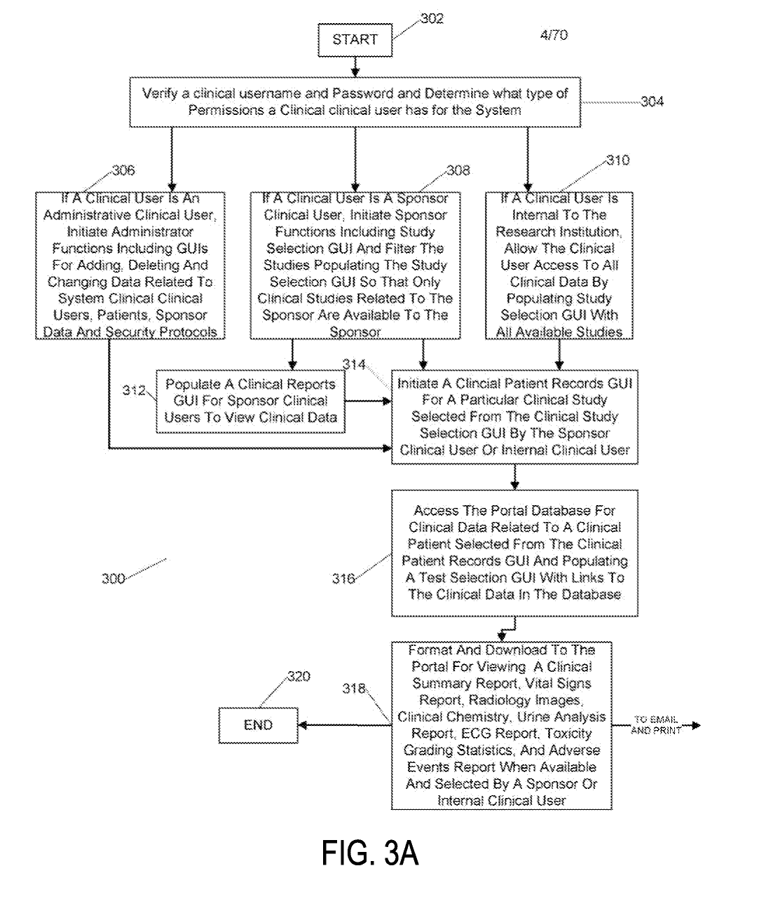

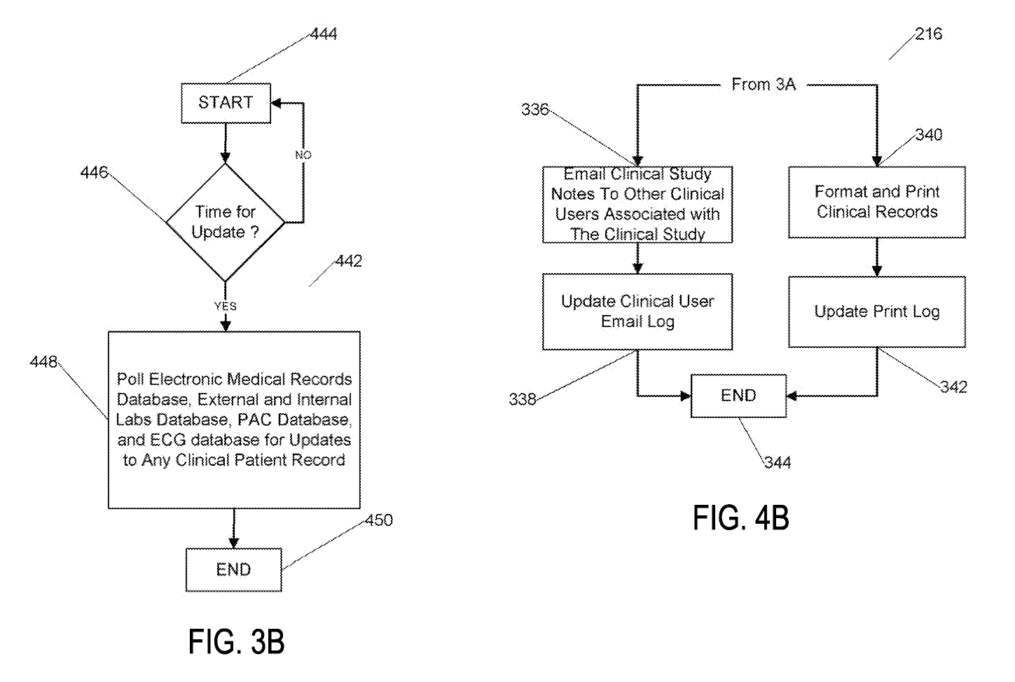

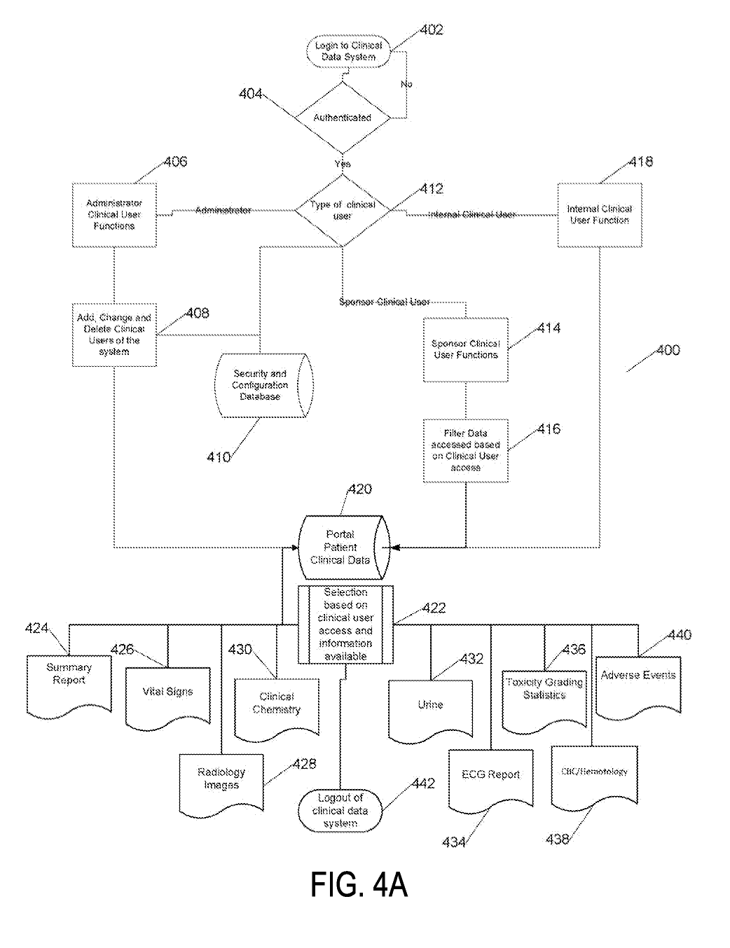

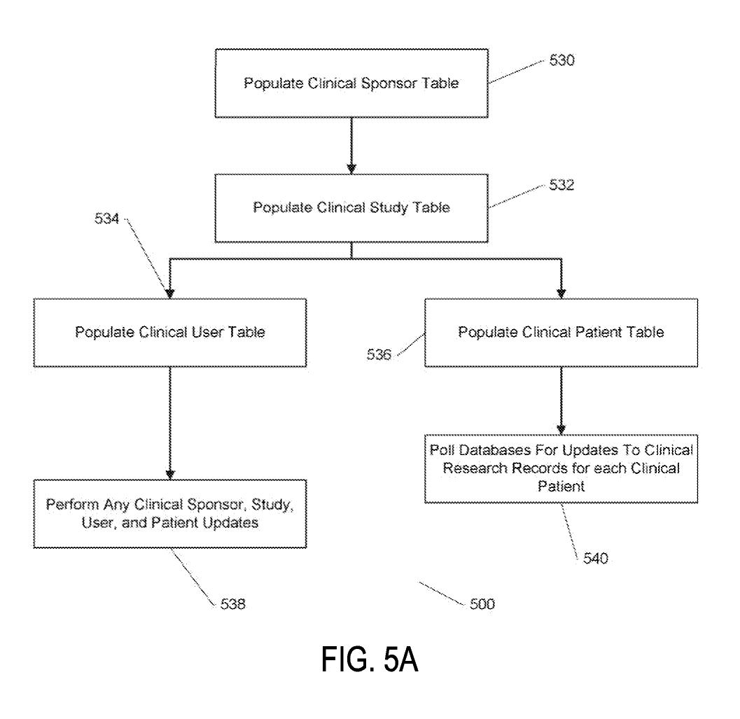

The sub-modules for each of the main modules of the program product of the instant invention will be described with reference to FIGS. 3A, 3B, 4A, and 4B. As shown in FIG. 3A, in the first step, the computer program product verifies a username and password and determines what type of permissions the clinical user has for accessing the machine (step 304). If a clinical user is an administrative clinical user, administrator functions, including the initiation of GUIs for allowing an administrative clinical user to add, delete and change data related to system clinical users, clinical patients, clinical sponsor data and security protocols, are opened for the clinical user (step 306). If A clinical user is a sponsor clinical user, sponsor functions, including the initiation of a clinical study selection GUI, are opened to the sponsor clinical user and the machine filters studies populating the clinical study selection GUI so that only clinical studies related to the clinical sponsor are available to the clinical sponsor user (step 308). The program product may also populate a clinical reports GUI for the sponsor clinical users to view the clinical data uploaded to the various machine databases (step 312). If a clinical user is internal to the research institution, the clinical user is allowed access to all clinical study data and the clinical study selection GUI is populated with all available studies (step 310). Once a clinical study is chosen, a clinical patient records GUI for a particular clinical study is populated so that a clinical user can select a particular clinical patient from the clinical patient records GUI (step 314). Once a clinical patient is chosen from the clinical patient selection GUI, applicable clinical data related to a clinical patient selected is accessed in the database and a test selection GUI with links to the clinical data in the database, is populated (step 316). After a clinical user selects the clinical data to view, a summary report, vital signs report, radiology images, clinical chemistry, urine analysis report, EKG report, toxicity grading statistics, CBC/hematology or adverse events report can be downloaded to the portal and viewed by the clinical user (step 318).

As can be seen in FIG. 3B, the clinical data manipulation module 216 can comprise several steps. For instance, the clinical data manipulation module 216 may allow a clinical user to email other clinical users associated with the clinical user's clinical study (step 336). And the step of updating an email log for a clinical user when a system email is sent or received (step 338). In this way, the machine can allow for collaboration, e.g., between institution clinical users and clinical study sponsors and email logs within the same machine and application. The data manipulation module 216 may also allow a clinical user to format and print clinical patient records (step 340) and update a print log (step 342) for the patient clinical data or clinical reports. In this way, the machine allows clinical users the ability to include clinical patient and clinical study data in paper clinical reports, disclosures, etc. As one skilled in the art will appreciate, access to email and print functions can be limited to the type of clinical user. For example, a clinical sponsor may want a secretary associated with the clinical sponsor to have print capabilities for the clinical reports, but not email capabilities. Or, the research institution may want to allow doctors the ability to view clinical patient records, but not to comment on clinical data or print the patient clinical study data.

A decision tree for the software program product is shown in FIG. 4A. The process steps of the decision tree begin when a clinical user accesses the portal and attempts to logon using the system login protocols (step 402). The machine verifies the whether or not a clinical user can be authenticated, and if not the clinical user is returned to the login prompt (step 404). As one skilled in the art will appreciate, the machine may only allow a specific number of login attempts before the machine is locked to a particular clinical user. The machine can lock to the clinical user for a specified time period, or can lock to a clinical user indefinitely, pending an administrator's release of the lock. In addition, the machine may include a prompt so that a lost password or clinical user login ID can be sent to a clinical users email account on file, and such a prompt is within the scope of this disclosure. Once the clinical user is authenticated, the machine determines what type of clinical user has logged on using the clinical user's clinical user ID (step 412). The clinical user can be an administrator clinical user, a sponsor clinical user, or an internal clinical user. If the clinical user is an administrative clinical user, administrative functions, e.g., GUIs, are loaded onto the portal for viewing and editing by the administrative clinical user (step 406). These GUIs include menus for adding or editing clinical sponsors, internal clinical users, administrators, clinical patients, permissions, password and clinical user ID formats and clinical study data into the portal database (step 408). These changes and additions are stored in a security and configuration database (step 410). If the clinical user is a sponsor clinical user, sponsor clinical user functions, e.g., GUIs are loaded into the portal for viewing by the sponsor clinical user (step 414). These functions include viewing sponsor clinical study data and clinical patient data associated with the clinical study data and for reviewing clinical data for report verification. Importantly, the sponsor clinical user functions are limited only to clinical studies associated with the clinical sponsor (step 416). In other words, clinical sponsors can only view clinical study data for studies it is clinical sponsoring. If a clinical user is an internal clinical user, internal clinical user functions, e.g., GUIs are loaded onto the portal for viewing and editing by the internal clinical user (step 418). For example, an internal clinical user may have access to all studies at a research institution to collaborate between colleagues etc.; alternatively, depending upon the clinical study protocol, an internal clinical user may be screened from some clinical studies at the institution. Accordingly, while it is depicted in the drawings that internal clinical users have access to all clinical data, an embodiment where some internal clinical users do not have access to all clinical data is within the scope of this disclosure and is included as an alternative embodiment herein. Each of the administrative clinical users, sponsor clinical users and internal clinical users have access to at least a portion of the portal database (step 420). The types of data a clinical user can access and the information available is determinative of whether the clinical user can access a particular clinical data report (step 422). For instance, a clinical user may be able to select a summary report 424, a vital signs report 426, radiology images 428, a clinical chemistry report 430, a urine report 432, an EKG report 434, a toxicity grading report 436, and an adverse events report 440 for a particular clinical patient as available. As one skilled in the art will appreciate, the types of clinical data and clinical reports loaded into the portal database are given by way of example and other types of clinical reports and patient clinical data may be included in the database, and the disclosure of specific clinical data and clinical reports should not limit the disclosure. Moreover, each of the clinical reports may have other equivalent or nearly equivalent studies or tests that may be conduct in the alternative, and such studies and tests can be included as clinical data in clinical test reports in the portal database and accessible to clinical users using the techniques disclosed herein. Accordingly, while all equivalents or near equivalents for tests and clinical test reports contained herein are not specifically disclosed, it is assumed that all equivalents and near equivalents are included within the scope of this disclosure and claims.

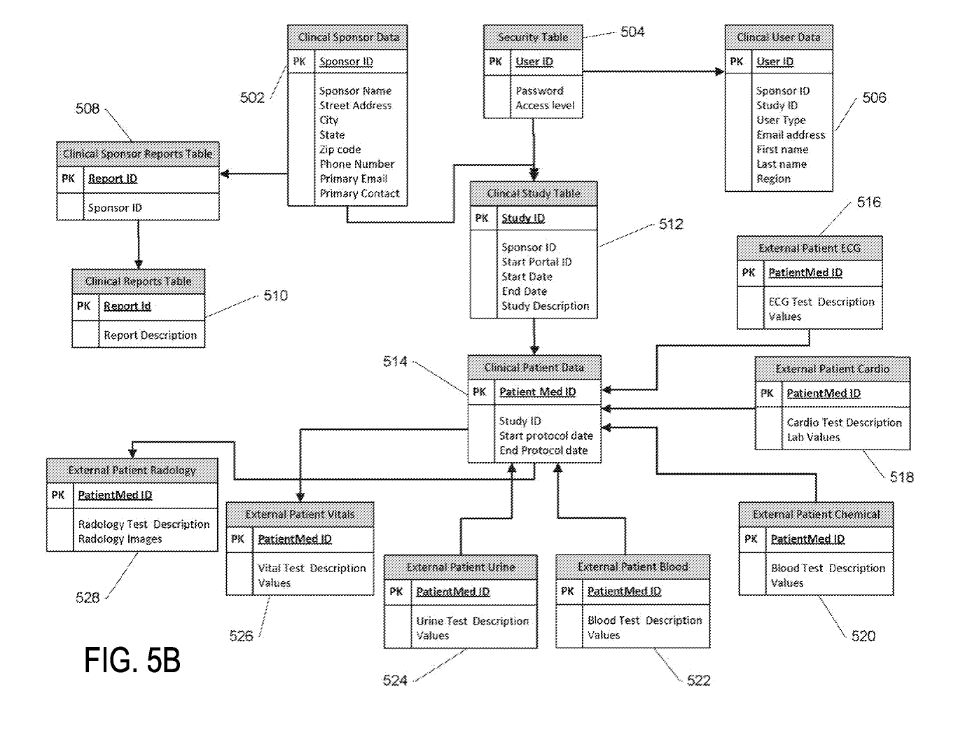

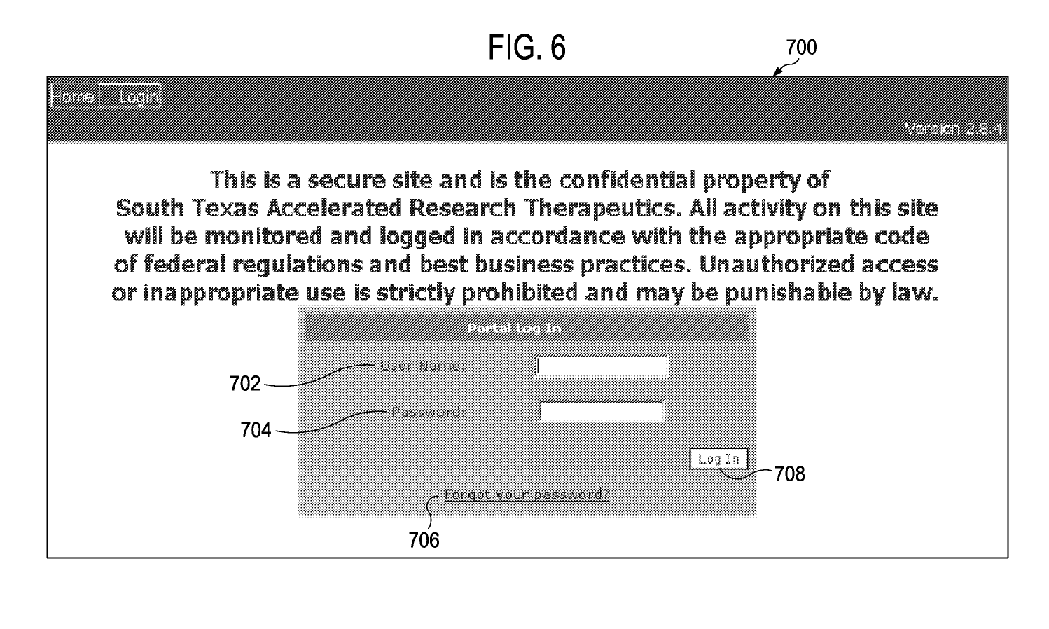

The data stored in memory 206, and used and uploaded to memory by the program product to perform the function herein, is stored in a relational database 500 depicted in FIGS. 5A and SB. As shown in FIG. 5A, the database is comprised of data tables that are populated for each clinical sponsor added to the database. The data tables are populated with data related to each clinical sponsor by first populating a clinical sponsor tables (step 530), then populating a clinical study tables (step 532), and finally populating clinical patient tables (step 536) and clinical user tables (534) and setting permissions for each clinical user associated with the each clinical study. Once the tables are populated, updates can be performed to the tables (step 538), and databases containing patient clinical records associated with each clinical patient may be periodically polled, e.g., every 24 hours, to update the patient clinical records in the portal database (step 540).

Turning to FIG. 5B, the database 500, is organized into several tables for each of the steps described in FIG. 5A, including a clinical sponsor data table 502, a security table 504, a clinical user data table 506, a clinical sponsor reports table 508, a clinical reports table 510, a clinical study table 512, a clinical patient data table 514, a external clinical patient EKG table 516, an external clinical patient cardio table 518, a external clinical patient chemical table 520, an external clinical patient blood table 522, an external clinical patient urine table 524, an external clinical patient vitals table 526, and an external clinical patient radiology table 528. Together these tables organize data by a primary key (PK) or column value, and rows such that each entry in the table has one unique value.

For the clinical sponsor data table 502, the primary key is the clinical sponsor ID, and the rows are defined by a clinical sponsor name, street address, city name, state name, zip code, phone number, primary email and primary contact. For the security table 504, the primary ID is a clinical user ID, and the rows are a clinical user's password and access lever. For the clinical user data table 506, the primary key is a clinical user ID, and the rows are defined by a clinical user's associated clinical sponsor ID and clinical study ID, a clinical user type, a clinical user's email address, a clinical user's first name, a clinical user's last name and a region the clinical user is from. For the sponsor clinical reports table 508, the primary key is a report ID, with the table's row is defined by a clinical sponsor ID for the report. For the clinical reports table 510, the primary key is the clinical report ID and the table's row is defined by the clinical report description. For the clinical study table 512, the primary key is the clinical study ID, and the rows are defined by the clinical sponsor ID, the start portal ID, the clinical study start date, the clinical study end date, and the clinical study description. For the clinical patient data table 514, the primary key is the clinical patient medical ID, and the rows are defined by the clinical study ID, the start protocol date for the clinical patient, and the end protocol date for the clinical patient. For the external clinical patient EKG table 516, the primary key is the clinical patient medical ID, and the rows are defined by the EKG test description and EKG test values. As one skilled in the art will appreciate, the EKG test value stored in the table could be a pointer to another portion of the database storing the EKG images. For the external clinical patient cardio table 518, the primary key is the clinical patient medical ID, and the rows are defined by the cardio test description and lab values. For the external clinical patient chemical table 520, the primary key is the clinical patient medical ID and the rows are defined by the blood test description and test values. For the external clinical patient blood table 522, the primary key is the clinical patient medical ID, and the rows are defined by the blood test description and the test values. For the external clinical patient urine table 524, the primary key is the clinical patient medical ID, with the rows being defined by the urine test description and the test values. For the external clinical patient vitals table 526, the primary key is the clinical patient medical ID, with the rows begin defined by the vitals test description and the test values. For the external clinical patient radiology table 528, the primary key is the clinical patient medical ID, with the rows being defined by the radiology image. As one skilled in the art will appreciate, the radiology image may be stored in a separate portion of memory, with the data in the table being a pointer, i.e., memory address, for the image data.

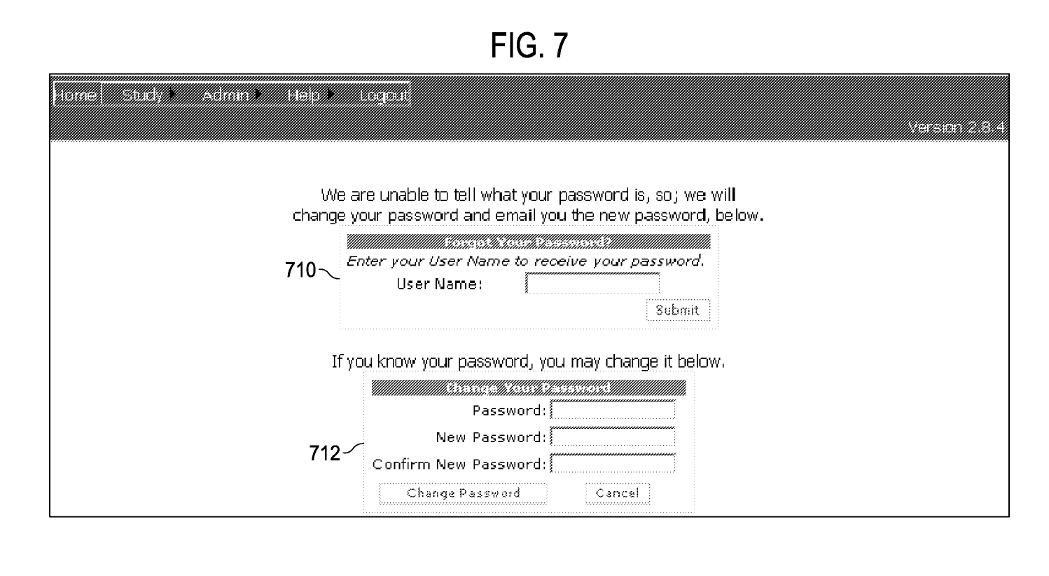

As one skilled in the art will appreciate, each of the relational tables may be used to construct graphical clinical user interfaces (GUIs) as described for the program product above that allow a clinical user to interact with the computer program of the instant invention, and exemplary GUIs and their functions will be described with reference to FIGS. 6 though 26.

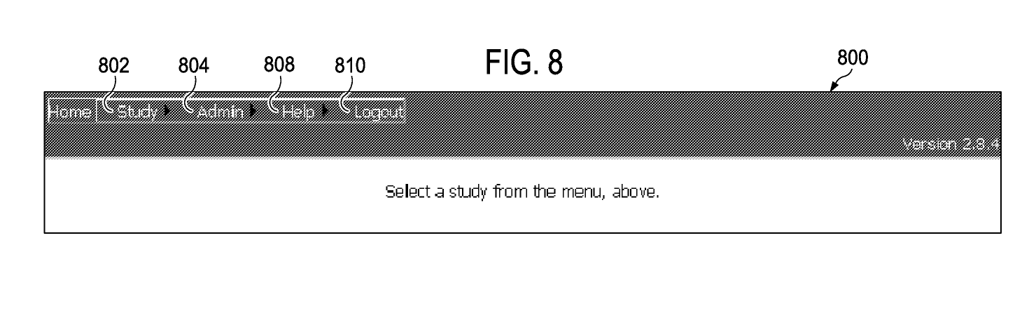

FIG. 6 is a computer display page showing a portal database start page according to an embodiment of the invention. As one skilled in the art will appreciate, a portal database start icon can be downloaded onto a clinical user's desktop, or alternatively, a clinical user can access the portal database via entering the address of the portal database webpage into the clinical user's browser. Once the start page is initiated, a clinical user login prompt 700 is loaded, as shown in FIG. 7A. As can be seen, the login prompt may also include a disclaimer, as shown, or may include a terms of use for the portal database. The login prompt 700 may also include a user name entry blank 702, a password blank 704, and a log in or enter button 708, in some embodiments of the invention. In use, such an embodiment accesses the portal database when a user enters a username and a password that match a valid account in the portal database. If a clinical user forgets its password, a “forgot password” prompt 706 can be used to access the “forgot password form” 710 or a change password form 712, shown in FIG. 7. In such embodiments, the forget password form 710 allows the clinical user to enter a valid user name and the computer system matches the clinical user name to an email address in the database to allow the clinical user to have its password emailed. The clinical user may also change its password using change password form 712, e.g., by entering a valid, unique password or by entering a user name and password, associated with a system user.

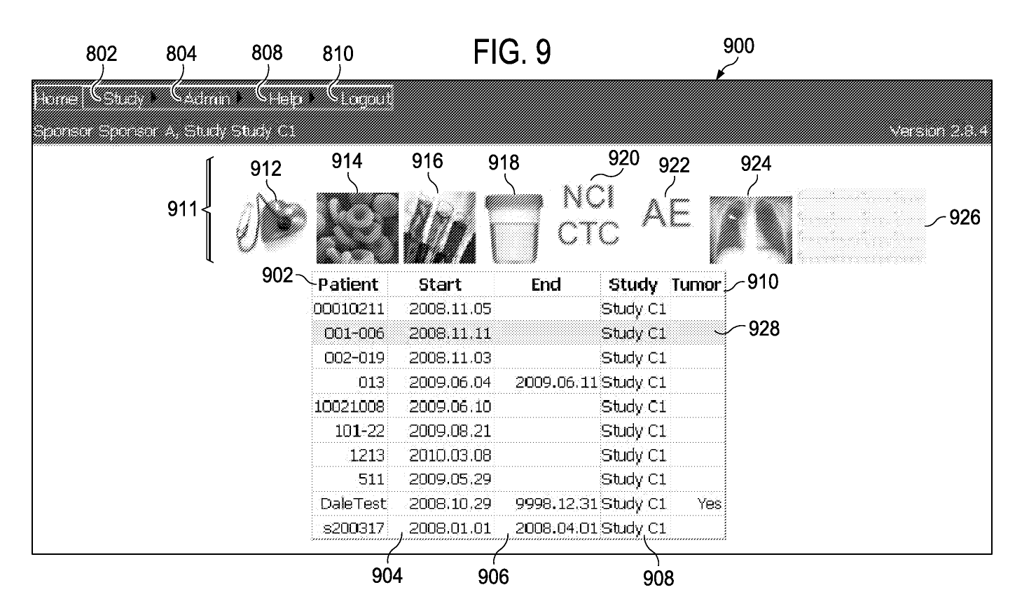

Once a clinical user has successfully logged into the portal database, a computer display page a portal database homepage 800 according to an embodiment of the invention is initiated, as shown in FIG. 8. The portal database homepage includes a clinical study tab 802, having, e.g., a drop down menu listing a plurality of studies that can be accessed by the clinical user; an administration tab 804, having, e.g. an associated drop down menu for adding or editing data regarding clinical users that can access the portal database, patients that are participating in studies; or studies that are being conducted; a help tab 806 having, e.g., an associated drop down menu listing various common help topics, and a logout tab 808 for, e.g., logging out of the portal database. As mentioned, when the clinical study tab 802 is selected, a dropdown menu showing every clinical study a clinical user can access appears.

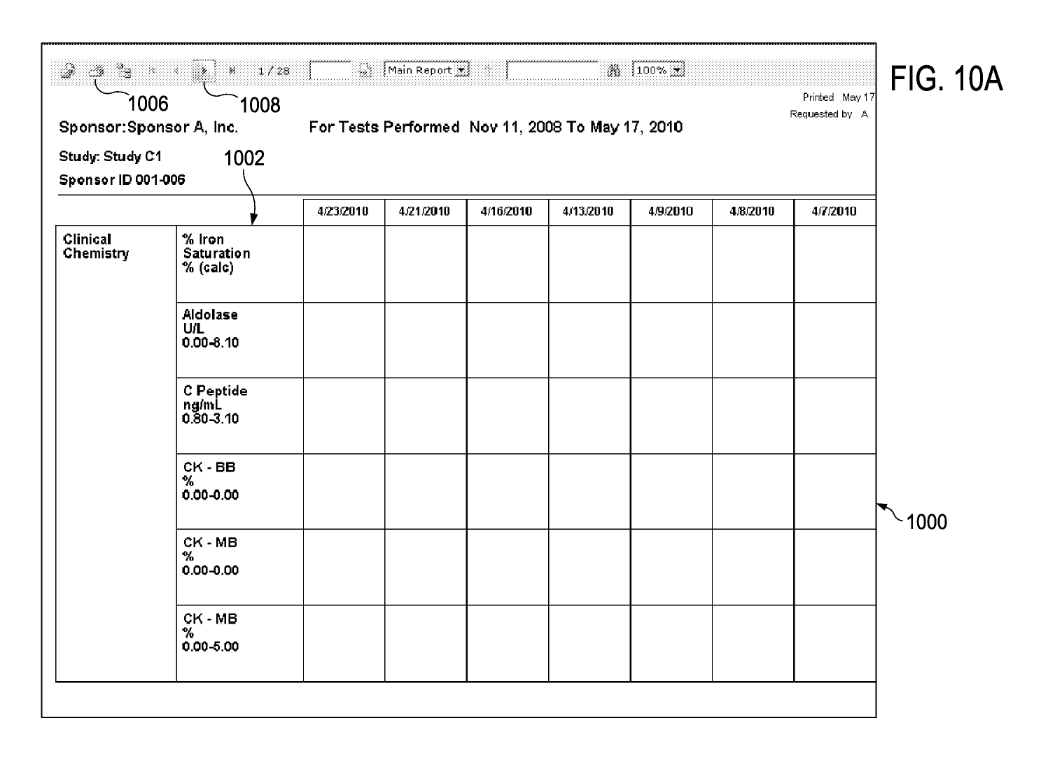

Once a clinical study is selected from the drop down menu, each clinical patient for the selected clinical study is displayed in, e.g., table form 900, as shown in FIG. 9. The table 928 has a clinical patient identification number 902, a date the clinical patient started the clinical study's clinical protocol 904, the date the clinical patient stopped participating in the clinical study's clinical protocol 906, the clinical study ID 908, and an indicator of whether or not the clinical patient has an observable tumor 910. From the table 900, a clinical user can select a particular clinical patient's record to view. Various report icons 911 may appear on the screen when a clinical patient is selected, or optionally may appear on the screen and be “live” only for patients having data populated in the associated databases. The report icons 911 may include a summary record icon (which may include a vitals report) 912, a blood count icon 914, chemical panel icon 916, a urine icon 918, a toxicity icon 920, an adverse events icon 922, a radiology icon 924, and a EKG 926. Each of these icons can be selected to pull the clinical test record associated with the icon.

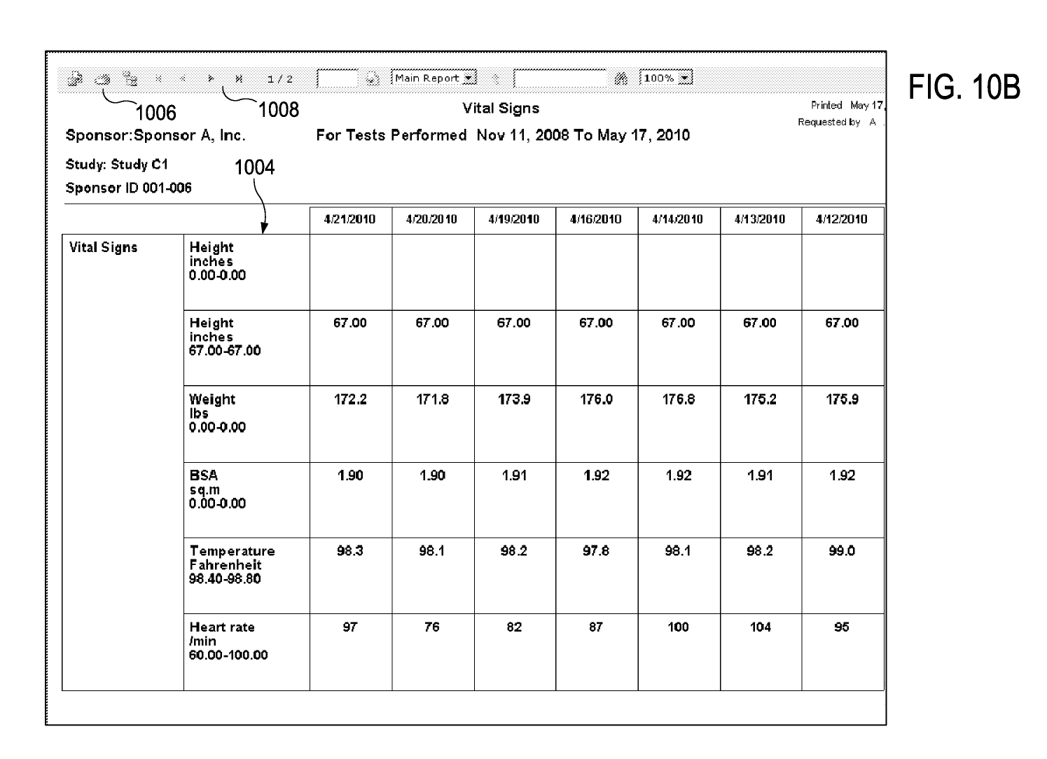

For example, FIG. 10 is a computer display page having a summary record 1000 for a particular clinical patient initiated upon the selection of the summary icon therein. Such summary record 1000 may include a clinical chemistry table 1002 and a vitals table 1004, shown in FIG. 10B. The clinical chemistry table 1002 may include, for example, an axis listing various clinical chemistry test, e.g., for albumin, alkaline phosphatase, blood urea nitrogen (BUN), calcium, carbon dioxide (CO2), chloride, serum creatinine (SCr), glucose, potassium, sodium, alanine transaminase (ALT), aspartate aminotransferase (AST), total protein, bilirubin, direct bilirubin, glucose, lactic dehydrogenase (LDH), magnesium, phosphorous, amylase, lipase, cholesterol, high density lipoprotein (HDL), low density lipoprotein (LDL), triglycerides, creatine kinase (CK) and its isoenzymes (CK-BB, CK-MB and CK-MM), troponin-I, troponin-T, iron saturation, aldolase, thyroid stimulating hormone (TSH), triiodothyronine (T3), thyroxine (T4), and uric acid arranged by test date. The vitals table 1004 may include as an axis various tests or measurements for clinical patient's vitals, including height, weight, body surface area (BSA), temperature, and heart rate, arranged by date. As can be seen, in some embodiments, the tables may be printed using the print icon 1006, or multiple pages of the summary record 1000 may be scrolled though using the scroll icons 1008.

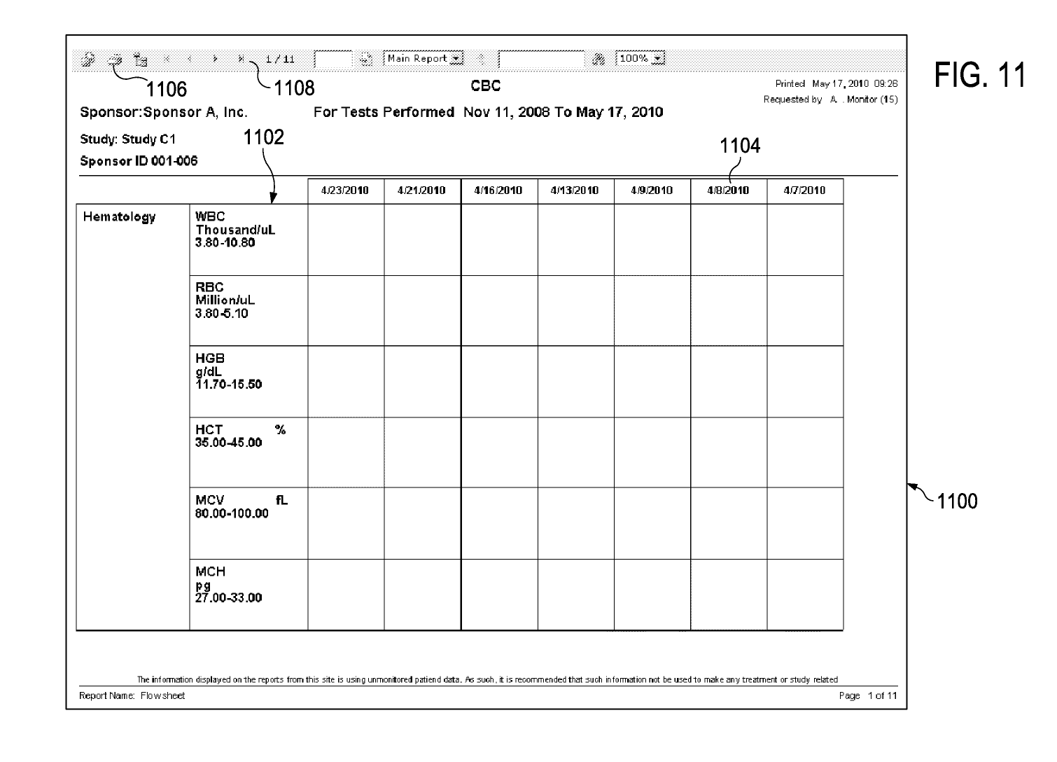

FIG. 11 is a computer display page having a complete blood count panel (CBC) record 1100 for a particular clinical patient disposed thereon, and initiated upon the selection of the blood count icon 914. As can bee seen, the CBC record 1100 may include, for example, a table having a CBC test or measurement listing 1102 as an axis, the CBC test or measurement listing including, for example, a patient's white blood cell count (WBC), red blood cell count (RBC), hemoglobin (HGB), hematocrit (HCT), platelets, mean corpuscular volume (MCV), mean corpuscular hemoglobin (MCH), red blood cell distribution, and mean corpuscular hemoglobin concentration. Similar to the summary table, the CBC table 1100 may also be arranged by test or measurement date 1104. As can also be seen, the CBC table 1100 may also include a print icon 1106 to allow the clinical user to print the panel or multiple pages of the CBC record 1100 may be scrolled though using the scroll icons 1108.

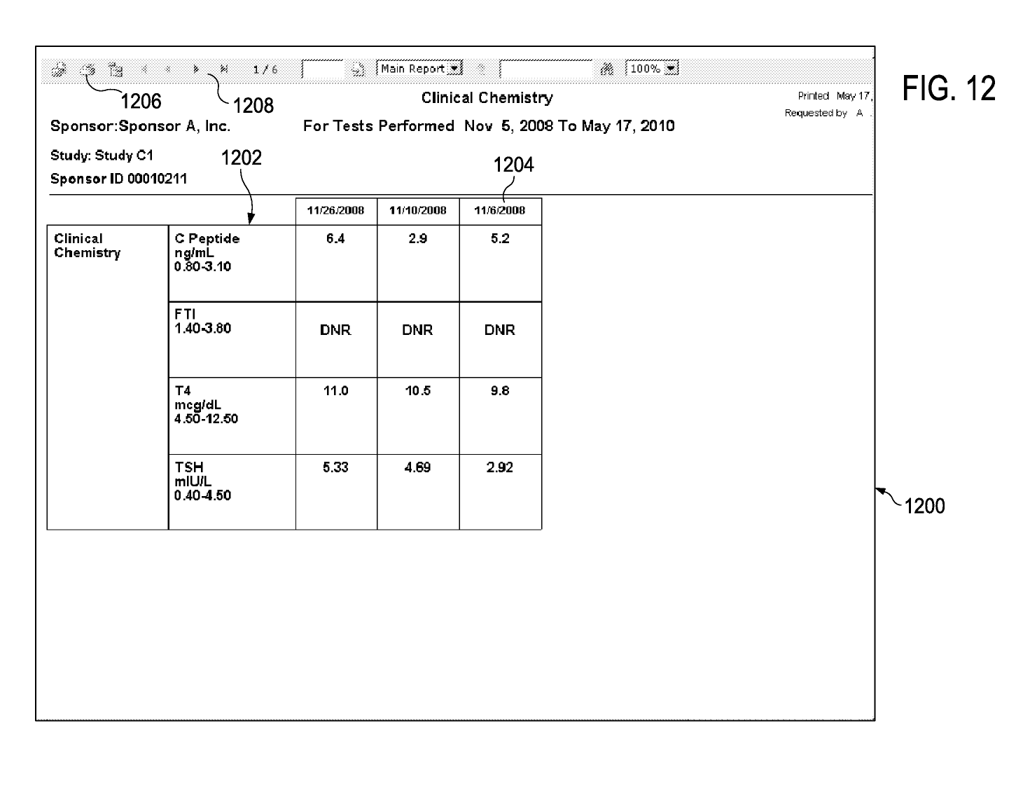

FIG. 12 is a computer display page having a clinical chemistry record 1200 for a particular clinical patient disposed thereon, and initiated upon the selection of the chemical icon 916. The clinical chemistry record 1200 may also be arranged as a table having a clinical chemistry test or measurement listing 1202 as an axis, the clinical chemistry test or measurement listing 1202 including, for example, a albumin, alkaline phosphatase, blood urea nitrogen (BUN), calcium, carbon dioxide (CO2), chloride, serum creatinine (SCr), glucose, potassium, sodium, alanine transaminase (ALT), aspartate aminotransferase (AST), total protein, bilirubin, direct bilirubin, glucose, lactic dehydrogenase (LDH), magnesium, phosphorous, amylase, lipase, cholesterol, high density lipoprotein (HDL), low density lipoprotein (LDL), triglycerides, creatine kinase (CK) and it's isoenzymes (CK-BB, CK-MB and CK-MM), troponin-I, troponin-T, iron saturation, aldolase, thyroid stimulating hormone (TSH), triiodothyronine (T3), thyroxine (T4), and uric acid_Similar to the summary table and CBC table, the chemistry record 1200 may also be arranged by test or measurement date 1204. As can also be seen, the clinical chemistry record 1200 may also include a print icon 1206 to allow the clinical user to print the panel or multiple pages of the clinical chemistry record 1200 may be scrolled though using the scroll icons 1208.

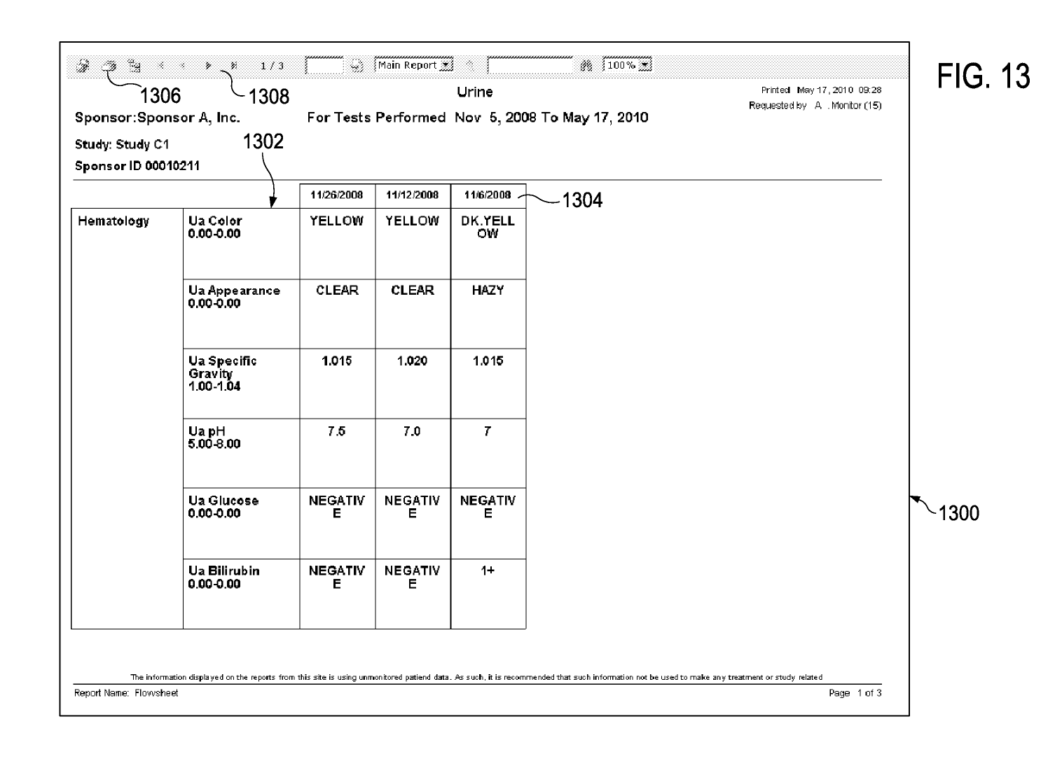

FIG. 13 is a display page having a urine record 1300 for a particular clinical patient initiated upon the selection of the urine icon 918. The urine record 1300 may also be arranged as a table having a urine test or measurement-listing 1302 as an axis, the urine test or measurement-listing 1302 may include, for example, tests or measurements for a urinalysis (Ua) including Ua color, Ua appearance, Ua specific gravity, Ua pH, Ua Glucose, and Ua bilirubin. Similar to the summary table and CBC table, the urine record 1300 may also be arranged by test or measurement date 1304. As can also be seen, the urine record 1300 may also include a print icon 1306 to allow the clinical user to print the panel or multiple pages of the urine record 1300 may be scrolled though using the scroll icons 1308.

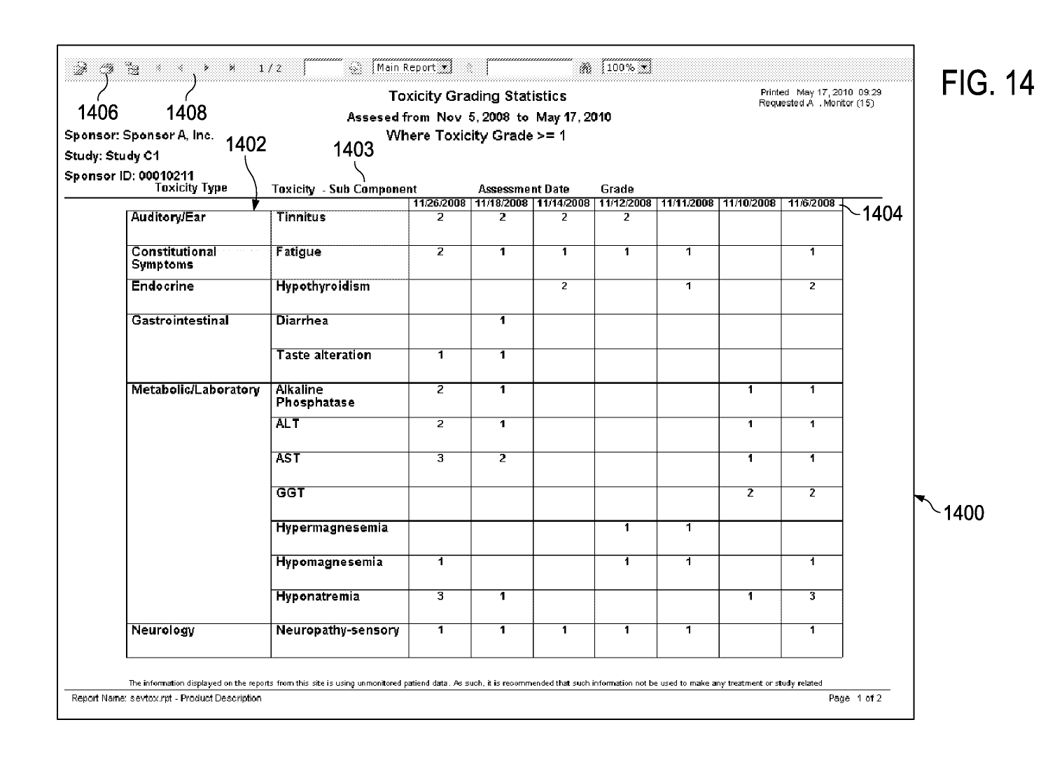

FIG. 14 is a computer display page having a toxicity grading statistics record 1400 for a particular clinical patient disposed thereon and initiated upon the selection of a toxicity icon 920. The toxicity grading statistics record 1400 may also be arranged as a table having vertical axis listing a toxicity type 1402, and sub components of the toxicity type 1403. The toxicity types may include, for example, toxicities that effect the ear, cause constitutional symptoms, effect the endocrine system, effect the gastrointestinal system, cause negative metabolic or laboratory results, or effect the neurological system. The toxicity sub components 1403, for example, may include tinnitus (ear), fatigue (constitutional symptoms), hypothyroidism (endocrine), diarrhea and taste alteration (gastrointestinal system), negative labs such as alkaline phosphatase, ALT, AST, GGT, hypermagnesemia, hypomagnesemia, and hyponatremia (metabolic/laboratory), and neuropathy-sensory (neurology). Thee toxicity subcomponents are from the common terminology criteria for adverse events (CTCAE) which is published by the US Department of Health and Human Services, and is accordingly understood by the art and incorporated herein by reference. As one skilled in the art will appreciate, there are thousands of toxicities that may be graded. Similar to the summary table, CBC table, etc, toxicity grading statistics record 1400 may also be arranged by test or measurement date 1404, and may include an assessment grade, indicative of the severity of the toxicity. This is graded on a scale of 1 to 5 with 1 being normal and 5 being the worst possible toxicity, including death. As can also be seen, toxicity grading statistics record 1400 may also include a print icon 1406 to allow the clinical user to print the panel or multiple pages of toxicity grading statistics record 1400 may be scrolled though using the scroll icons 1408.

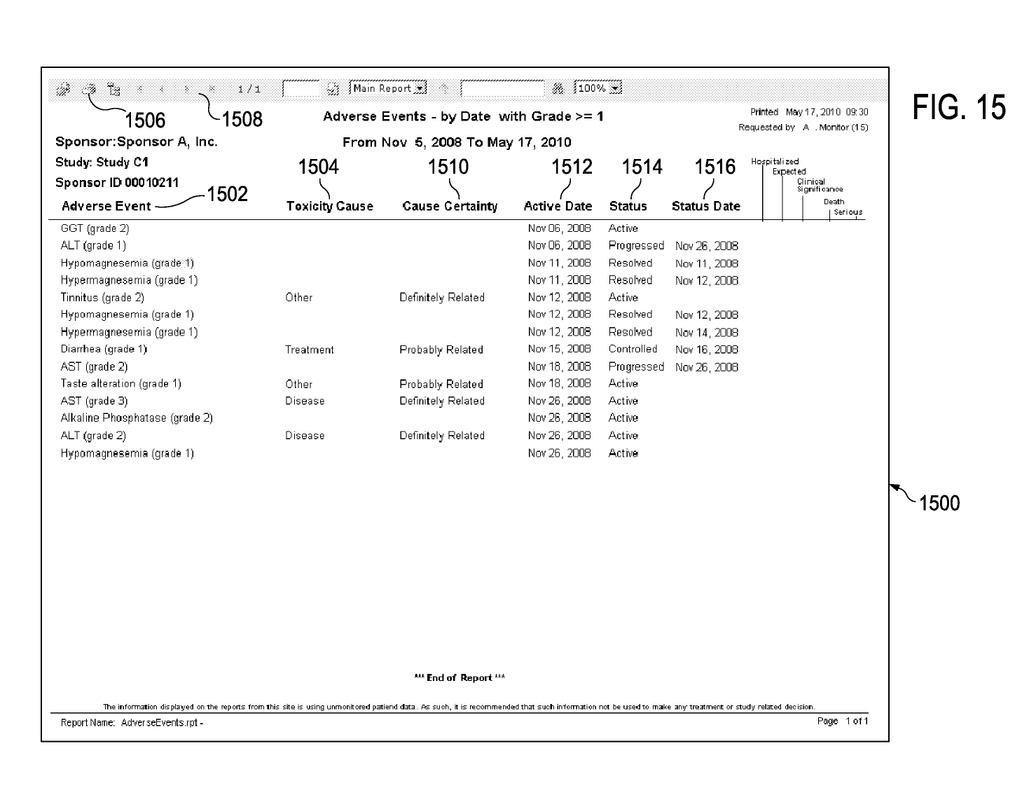

FIG. 15 is a display page having an adverse events record 1500 for a particular clinical patient disposed thereon and initiated upon the selection of an adverse events icon 922. The adverse events record 1500 may also be arranged as a table having, for example, a column including an adverse event listing 1502, which could include the toxicity sub components 1403, e.g., tinnitus, fatigue, hypothyroidism, diarrhea, taste alteration, negative labs such as alkaline phosphatase, ALT, AST, GGT, hypermagnesemia, hypomagnesemia, and hyponatremia, and neuropathy-sensory; a column for the toxicity cause 1504, for example, the treatment, the disease, or some other factor; a column for the cause certainty 1510, e.g., probably related, definitely related; a column for the active date of the adverse event 1512; a column for the status of the adverse event 1514; and a column for the status date 1516. The table may also include a listing of adverse events for a particular date range, or adverse events with a particular grade, e.g., greater than one. As can also be seen, the adverse events record 1500 may also include a print icon 1506 to allow the clinical user to print the panel or multiple pages of the adverse events record 1500 may be scrolled though using the scroll icons 1508.

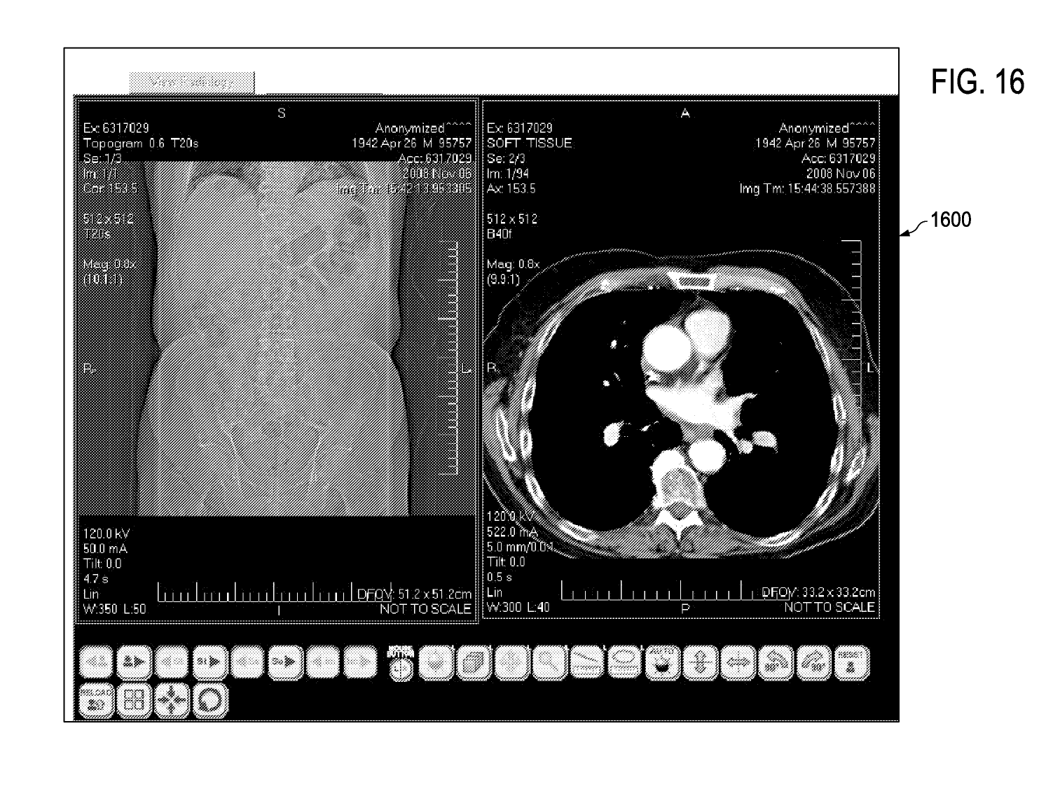

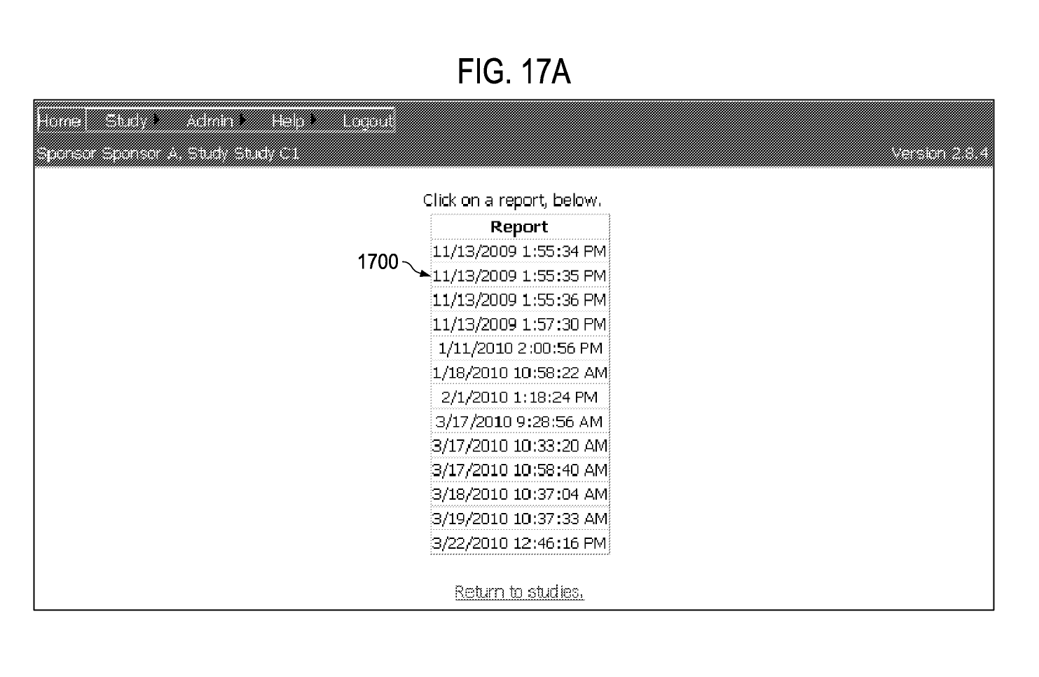

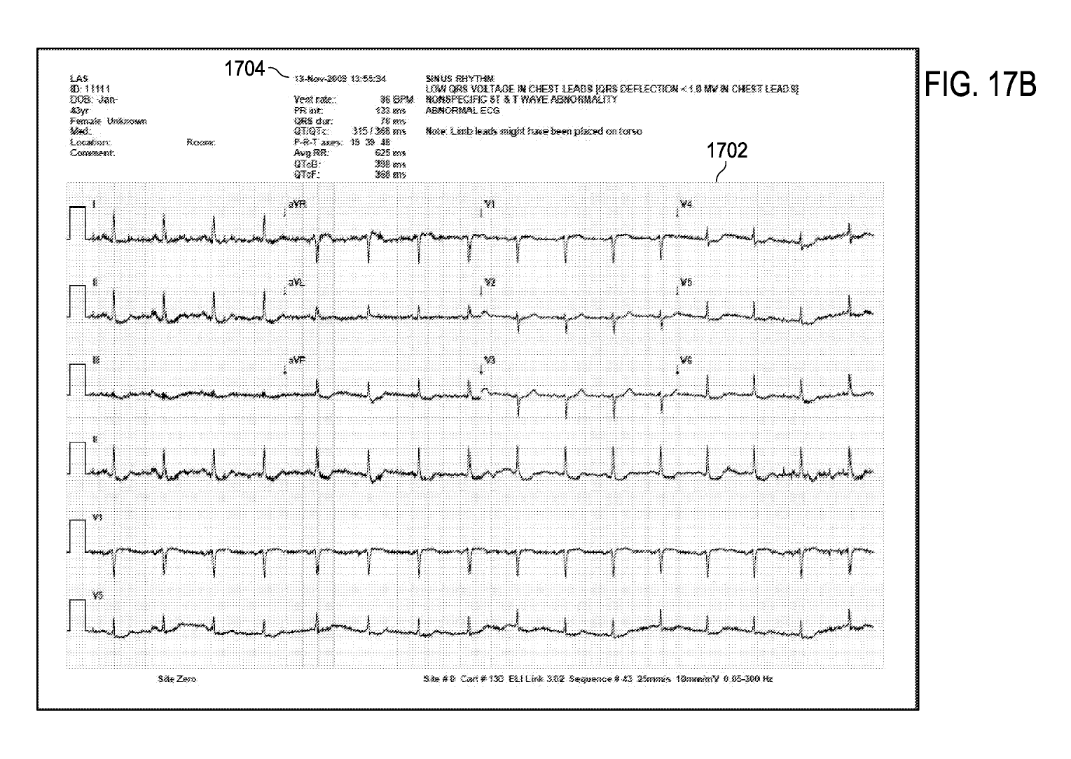

FIGS. 16, 17A, and 17B are related to the radiology icon 924 and cardiology icon 926. FIG. 16 is a computer display page having a radiology image 1600 for a particular clinical patient disposed thereon and initiated upon the selection of the radiology icon 924. As one skilled in the art will appreciate, the radiology image 1600 can be a chest x-ray, CAT scan, MRI, PET scan or the like, and may be uploaded to the system by a clinical administrator, or via a connection with a test facility, doctor or hospital associated with the clinical patient. FIG. 17A is a display page having a list of cardiology clinical reports 1700 for a particular clinical patient disposed thereon and initiated upon the selection of the cardiology icon 926. As can be seen, a particular patient may have several EKGs or echocardiogram 1700 associated therewith, each of which can be selected and viewed by the clinical user. Once a particular EKG 1700 is selected by the clinical user, a display page having a EKG 1702, for example, an EKG, for a particular clinical patient disposed thereon is initiated.

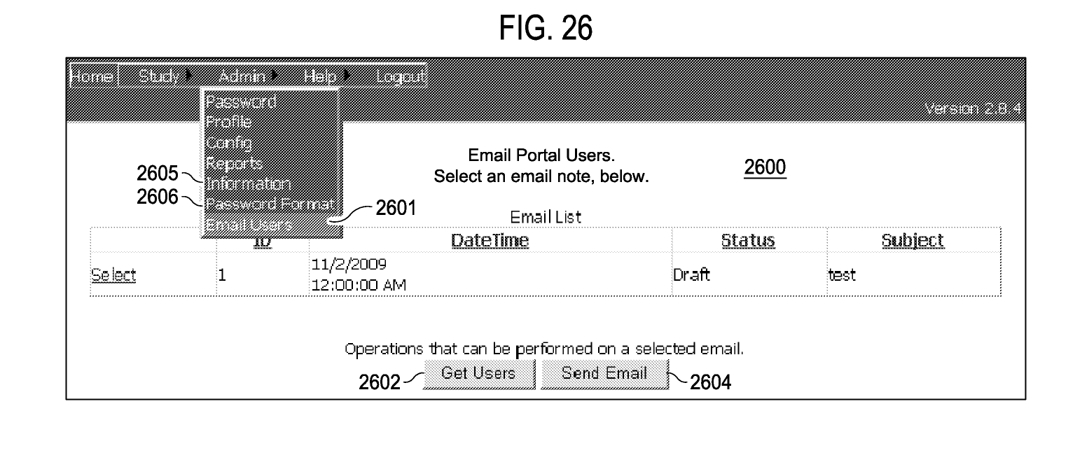

Returning to FIG. 8, the clinical user also has the option of selection the administrative menu 804. The administrative menu 804 may include prompts for changing a user's password; updating a clinical user's profile; changing the configuration of user profile, study profiles, or sponsor profiles; generating clinical reports; changing a password format; and emailing other clinical users of the system. Some of these activities are administrative functions, i.e., changing the configuration of user profile, study profiles, or sponsor profiles; and changing a password format may only be accessed by administrative clinical users and not general clinical users. Other prompts may be accessed by some clinical users associated with a study, e.g., changing a user's password; updating a clinical user's profile; generating clinical reports; and emailing other clinical users of the system with access to a particular study. In other words, administrative clinical users will have access to all functions under the administrative menu, but a sponsor clinical user may only have access to the information or email clinical users function under the administrative menu. Specifically, the selections under the administrative drop down menu may include, for example, password, profile, configuration, clinical reports, information, password format and email clinical users (shown in FIG. 26).

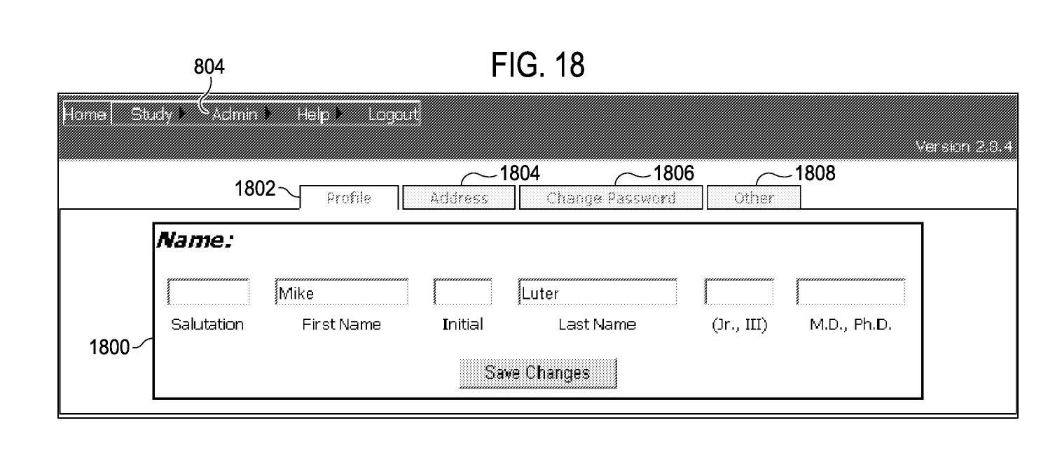

FIG. 18 is a computer display page of a profile menu 1800 initiated when “profile” is selected from the administrative menu 804 and includes a profile tab 1802, an address tab 1804, a change password tab 1806, and an other tab 1808. An address form (not shown), initiated upon the selection of address tab 1804, may include, for example, fields for entering a street, department, city, building, state, zip code, country, email address, phone number, cell phone number and fax number for a clinical user. A password entry form (not shown), may be initiated upon the selection of change password tab 1806, and may include fields for an old password and a new password. The other display (not shown) initiated upon the selection of the other tab 1808, may include a prompt that, e.g., allows a clinical user to download a short cut icon for the portal database login page to its computer. When the administrative clinical user has completed any updates of the profile menu 1800, including those appearing on the profile tab 1802, address tab 1804, change password tab 1806 and other tab 1808, the user can save the changes into the system by selecting or “clicking” the save changes button 1810.

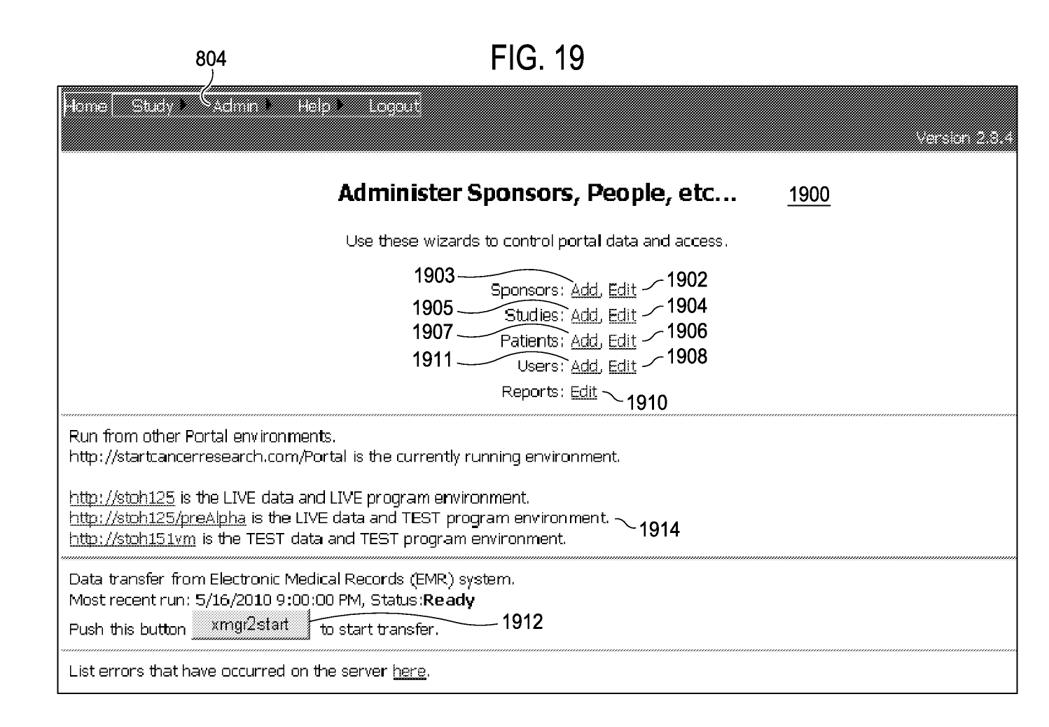

Returning to the administration menu 808 on the portal database homepage, a computer display page of a configuration menu 1900 is initiated upon the selection of “config”, as shown in FIG. 19. The configuration menu 1900 is accessible only to administrative clinical users, and allows administrative clinical users to add or edit clinical sponsors, studies, clinical patients, clinical users, and edit clinical reports. As can be seen, the sponsors additions or edits may be initiated via the selection of “add” tab 1903 or “edit” tab 1902 adjacent to the term “Sponsors”. Similarly, additions or edits to the studies managed by the system may be initiated via the selection of “add” tab 1905 “edit” tab 1904 adjacent to the term “Studies”; additions or edits to the patients participating in a particular study managed by the system may be initiated via the selection of “add” tab 1907 or “edit” tab 1906 adjacent to the term “Patients”; additions or edits to the clinical user profiles participating in a particular study managed by the system may be initiated via the selection of “add” tab 1909 or “edit” tab 1908 adjacent to the term “Users”; and reports of study data, clinical users login data; system data uploads, and other such information can be printed or edited using the “edit” tab 1910 adjacent to the term “Reports”. The configuration menu 1900 may also include electronic medical records transfer tab 1912 that allows a clinical administrative user to link to an Electronic Medical Records (EMR) system located at, e.g., a hospital, laboratory; clinic or doctor's office, to upload clinical patient data to the system. In some embodiments, the configuration menu 1900 may also allow the administrative clinical user to view system alerts 1914, i.e., systems or networks running, data alerts, etc, or note any systems errors occurring on the server for technical support personnel.

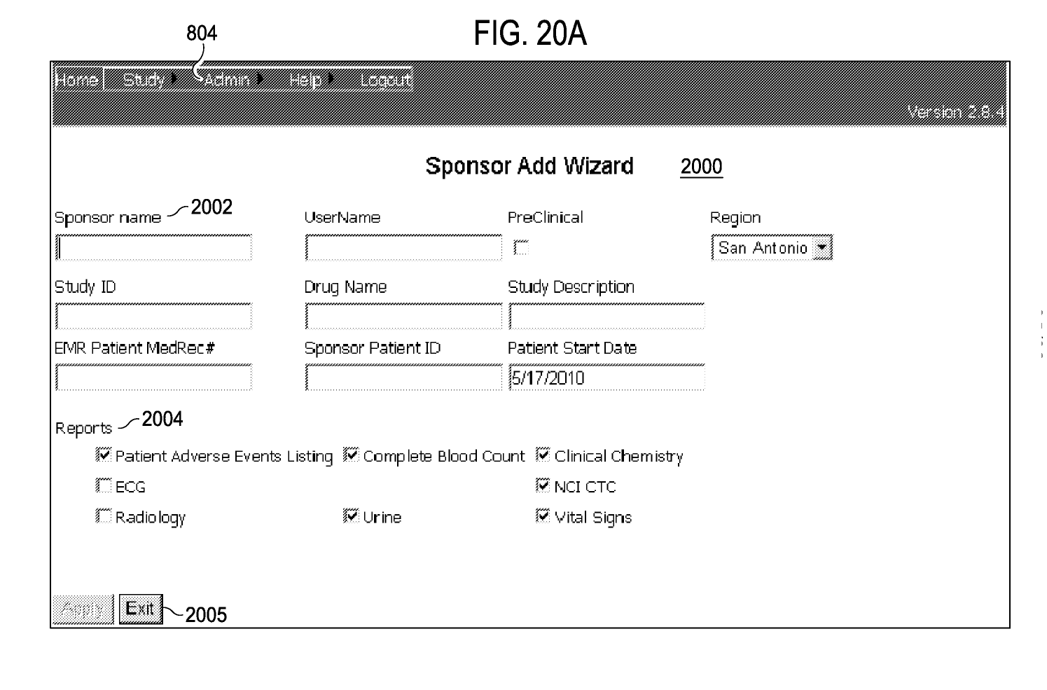

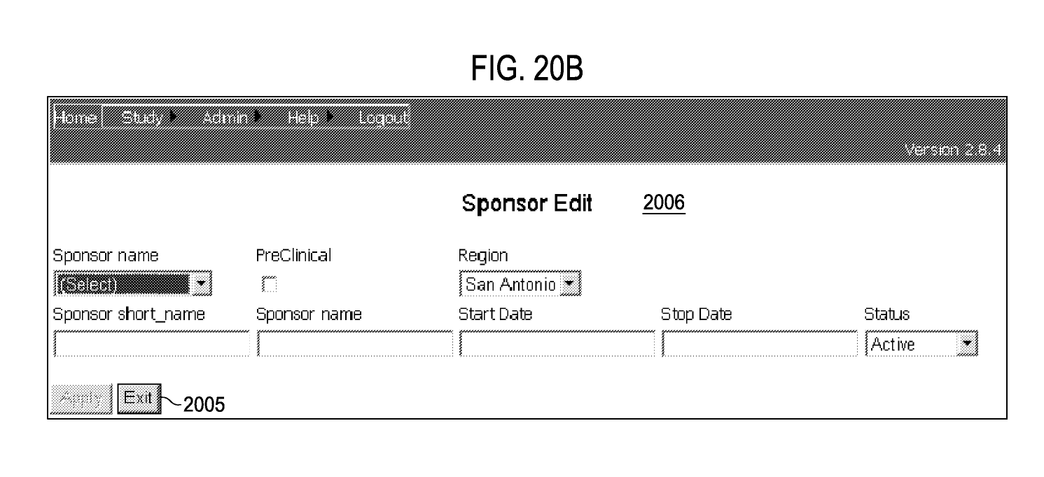

Turning to FIGS. 20a and 20b, the display pages having a clinical sponsor add wizard 2000 disposed thereon and initiated upon the selection of clinical sponsor add tab 1903 from the configuration menu and a clinical sponsor edit wizard 2006 disposed thereon and initiated upon the selection of clinical sponsor edit tab 1902 from the configuration menu 1900 are shown. The clinical sponsor add wizard 2000 allows the administrative clinical user to add sponsors to the database, e.g., when a new drug company sponsors research at the research institution. The clinical sponsor add wizard includes sponsor data fields 2002 for sponsor data, for example, a clinical sponsor name field, a clinical username field, a preclinical field, a region field, a clinical study ID field, a drug name field, a clinical study description field, a EMR clinical patient medical record number, a sponsor clinical patient ID, and a clinical patient start date. The administrative clinical user can also determine the types of clinical reports 2004 the clinical sponsor wants to review using the reports fields, e.g., by checking boxes next to report types such as patient adverse events listing, ECG, radiology, complete blood count, urine, clinical chemistry, NCI CTC, and vital signs. As one skilled in the art will appreciate, once the data is entered into the sponsor data fields 2002, the clinical user can save and exit the clinical sponsor add wizard 2000 by clicking the “apply” and “exit” buttons 2005, the “apply” button saving any updates or changes to the system, and the “exit” button, exiting the screen and returning to the portal home page.

The clinical sponsor edit wizard 2006 allows an administrative clinical user to edit sponsor data in the portal database. The clinical sponsor edit wizard may include a clinical sponsor name selection drop down menu to aid the administrative clinical user in locating the sponsor record. The clinical sponsor edit wizard 2006 may also include a pre-clinical field, a region field (indicating where the research is being conducted), a clinical sponsor short name field, a clinical sponsor name field, a clinical study start date, a clinical study stop date, and a status of the clinical study field. As one skilled in the art will appreciate, once the data is entered, the clinical user can save and exit the clinical sponsor edit wizard 2006 by clicking the “apply” and “exit” buttons 2005, the “apply” button saving any updates or changes to the system, and the “exit” button, exiting the screen and returning to the portal home page. As one skilled in the art will also appreciate, using the GUIs for the clinical sponsor edit and clinical sponsor add wizards; an administrative clinical user can simplify data entry into the portal database tables by using the aforementioned data fields.

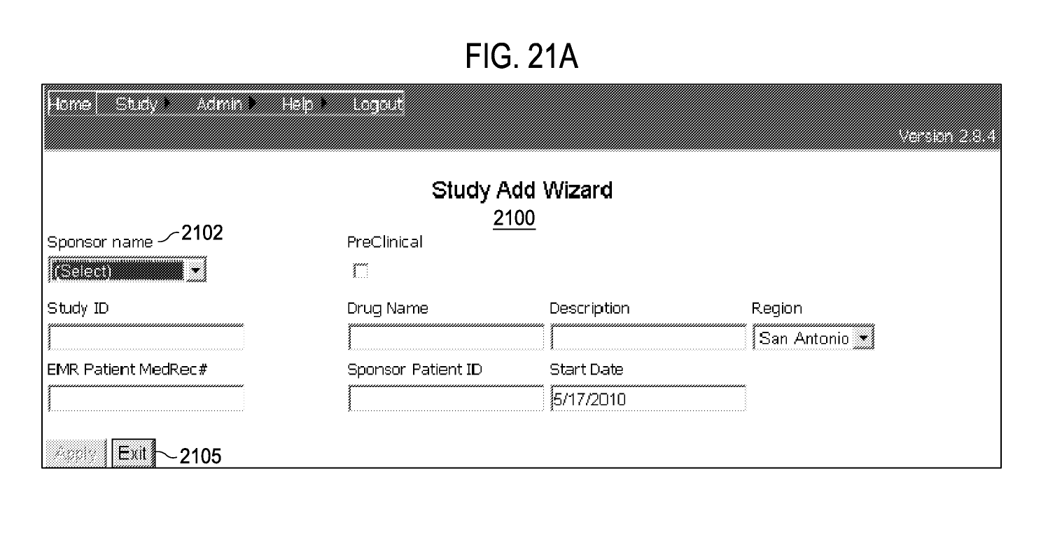

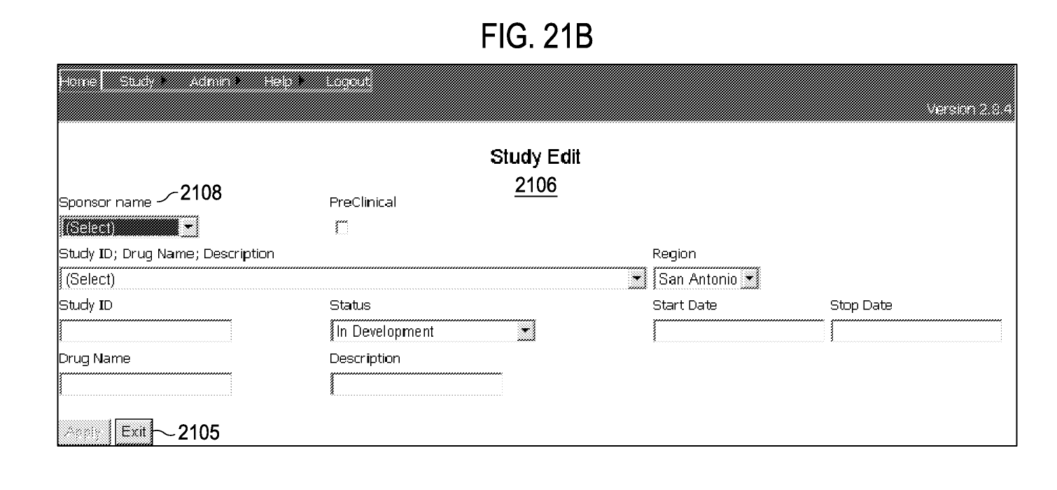

Turning to FIGS. 21a and 21b, the display pages having a clinical study add wizard 2100 disposed thereon and initiated upon the selection of clinical study add tab 1905 from the configuration menu and a clinical study edit wizard 2106 disposed thereon and initiated upon the selection of clinical sponsor edit tab 1904 from the configuration menu 1900 are shown. The clinical study add wizard 2100 allows the administrative clinical user to add clinical studies to the database, e.g., when a drug company sponsors new research at the research institution. The clinical study add wizard 2100 includes study data fields 2102 for study data, for example, a clinical sponsor name field, a pre-clinical field, a clinical study ID field, a drug name field, a description field a region field, an EMR clinical patient medical record number field, a sponsor clinical patient ID, and a clinical study start date field. The a clinical study add wizard 2100 can include, for example, a drop down menu of system clinical sponsor names and a drop down menu of regions the studies are being conducted in to aid the administrative user in the selection of appropriate data in some embodiments of the invention. As can be seen using the study data fields 2102, an administrative user can quickly add clinical studies to the system. As one skilled in the art will appreciate, once he data is entered into the study data fields 2102, the clinical user can save and exit the clinical study add wizard 2100 by clicking the “apply” and “exit” buttons 2105, the “apply” button saving any updates or changes to the system, and the “exit” button, exiting the screen and returning to the portal home page.

The clinical study edit wizard 2106 allows an administrative clinical user to edit sponsor data in the portal database. The clinical study edit wizard 2106 may include includes a clinical sponsor name field, a pre-clinical field, a clinical study ID, drug name and description field, a region field, a clinical study ID field, a status field, a start date field, a stop date field, a drug name field, and a description field. The clinical study edit wizard 2106 allows the administrative clinical user to edit clinical studies in the portal database for a particular clinical study sponsor. The clinical study edit wizard 2106 may include a drop down menu of system clinical sponsor names to select the clinical sponsor record to edit, a drop down menu for the clinical study ID, drug name and description, a drop down menu to identify the regions in which the clinical study is being conducted, and a drop down menu of clinical study status entries for selection according to the status of the clinical study, which can include, for example: in development, author review, active, temp closed to accrual, temp closed to accrual and treatment, closed—RX continues, closed RX completed, and completed. As one skilled in the art will appreciate, using the GUIs for the clinical study edit and clinical study add wizards; an administrative clinical user can simplify data entry into the portal database tables. As one skilled in the art will also appreciate, once the data is entered, the clinical user can save and exit the clinical study edit wizard 2106 by clicking the “apply” and “exit” buttons 2105.

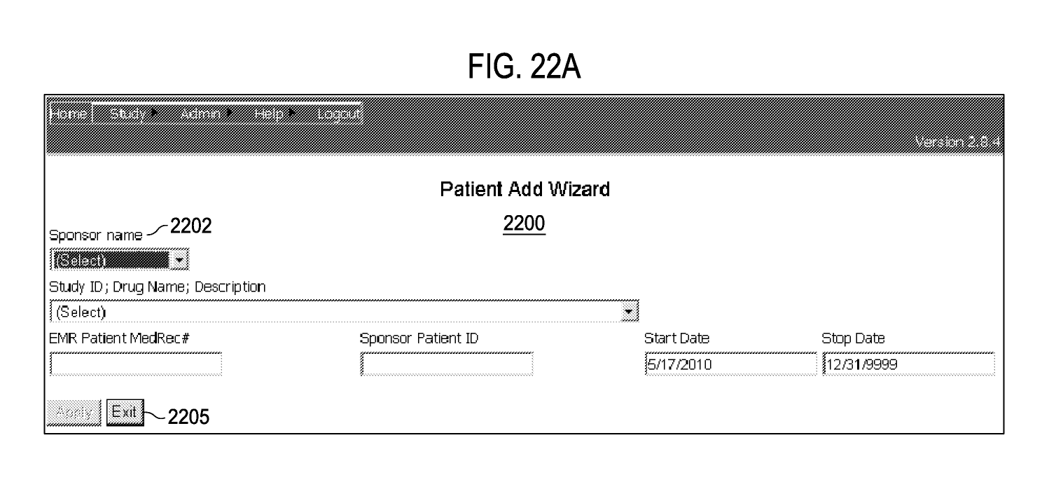

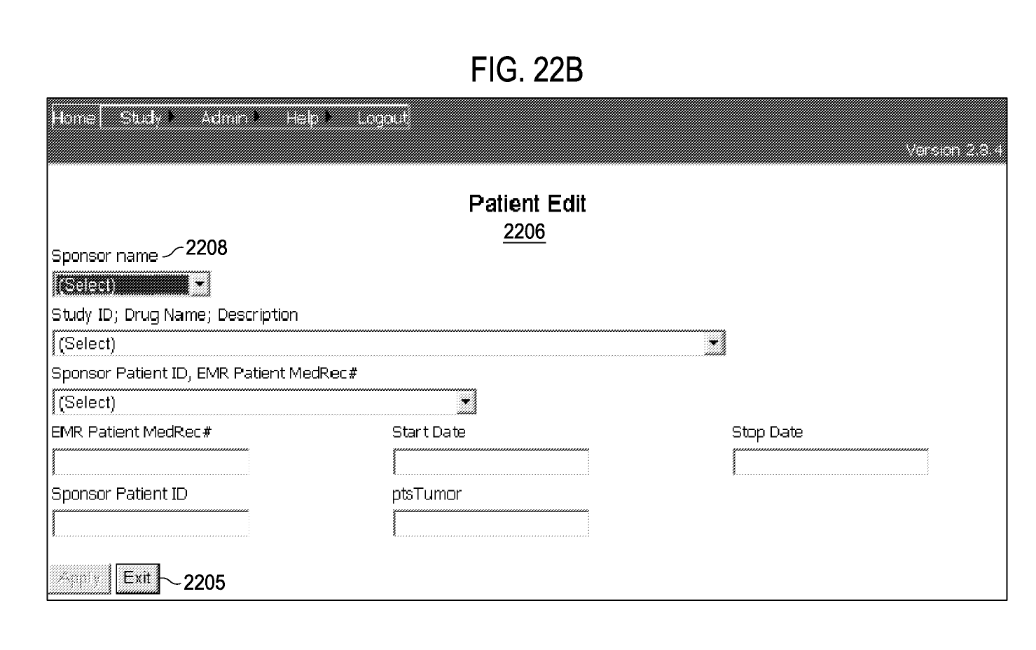

Turning to FIGS. 22a and 22b, the display pages for a clinical patient add wizard 2200 initiated upon the selection of clinical patient add tab 1907 from the configuration menu and a clinical patient edit wizard 2206 initiated upon the selection of clinical patient edit tab 1906 from the configuration menu 1900. The clinical patient add wizard 2200 allows the administrative clinical user to add clinical patients to the database, e.g., when a drug company sponsors new research at the research institution or patients are added to a clinical study. The clinical patient add wizard 2200 includes patient data fields 2202 for patient data, for example, a clinical sponsor name field, a clinical study ID, drug name, and description field, a EMR clinical patient medical record number field, a sponsor clinical patient ID field, a patient clinical study start date field and a patient clinical study end date field. As one skilled in the art will appreciate, the patient data fields can be used to link EMR data uploaded to the system using EMR tab 1912 to the associated study, sponsor and patient record. The a clinical patient add wizard 2200 can include, for example, a drop down menu of system clinical sponsor names and a drop down menu of regions the studies are being conducted in to aid in the selection of appropriate data in some embodiments of the invention. As one skilled in the art will also appreciate, once the patient data fields are complete, at least to predefined levels of completion, the clinical user can save and exit the clinical patient add wizard 2200 by clicking the “apply” and “exit” buttons 2205.

The clinical patient edit wizard 2206 allows an administrative clinical user to edit data in the portal database. The clinical patient edit wizard 2206 may include fields for editing a clinical sponsor name, a clinical study ID, drug name and description field, a EMR clinical patient medical record number field, a sponsor clinical patient ID field, a tumor size field, a patient clinical study start date field and a patient clinical study end date field. The clinical patient edit wizard 2206 allows the administrative clinical user to edit clinical studies in the portal database for a particular clinical study sponsor. The clinical patient edit wizard 2206 may include a drop down menu of system clinical sponsor names to select the clinical sponsor record to edit, a drop down menu for the clinical study ID, drug name and description, and a drop down menu that includes a sponsor patient ID and EMR patient medical record number. As one skilled in the art will appreciate, once the patient data fields are complete, at least to predefined levels of completion, the clinical user can save and exit the clinical patient edit wizard 2206 by clicking the “apply” and “exit” buttons 2205. As one skilled in the art will also appreciate, using the GUIs for the clinical study edit and clinical study add wizards; an administrative clinical user can simplify data entry into the portal database tables.

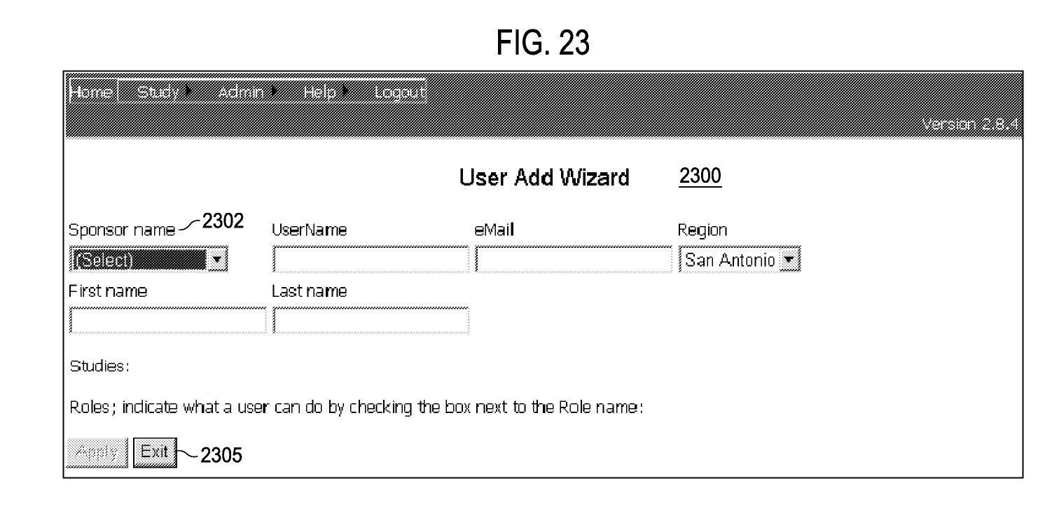

FIG. 23 is a display page having of a clinical user add wizard 2300 disposed thereon and initiated upon the selection of clinical user add tab 1908 from the configuration menu 1900 according to an embodiment of the invention. The clinical user add wizard includes clinical user data fields 2302 for entry by the administrative clinical user, including for example, a clinical sponsor name field, a clinical username field, a email field, a region field, a first name field, a last name field and a role field. The clinical user add wizard allows the administrative clinical user to add clinical users to a particular study associated with a particular sponsor in the portal database and to select the types of activities the clinical user can perform within the system based upon duties and responsibilities, e.g., administrative clinical user may have access to data to the configuration menu 1900, drug sponsor clinical user may have access to report and email functions, physician user may have access to EMR upload capabilities, etc. As one skilled in the art will appreciate, the clinical user add wizard 2300 may also include drop down menus for clinical sponsor names and regions or facilities where the research is being conducted to aid the administrative clinical user in data entry, i.e., to ensure the administrative user, e.g., enters relevant data into the data fields.

The administrative clinical user may also initiate a computer display page having a personnel management menu 2400 disposed thereon upon the selection of clinical user edit 1908 from the configuration menu according to an embodiment of the invention. The personnel management menu 2400 can include a drop personnel down menu 2401 for selecting a clinic user's field to edit, and tabs to select a category for editing, e.g., a clinical user profile tab 2402, an address tab 2404, an account tab 2406, a clinical study access tab 2408, and a clinical roles tab 2410.

The personnel management menu allows an administrative clinical user the ability to edit the profile, address, clinical study access, and roles for the selected particular clinical user. For example, the clinical user profile tab 2402 may include fields that allow the administrative clinical user to edit a selected clinical users name and region, e.g., fields for the clinical user's first name, last name, middle initial, title, etc. Similarly, the clinical user's address tab 2404 may allow the administrative clinical user to modify a selected clinical user's address, e.g., include an institution field, a company name field, a street name field, a department field, a city field, a building field, a country field, a state field, a zip code field, a email address field, a cell phone field, a phone number field, and a fax number field. The account tab 2406 may allow the administrative clinical user to modify the selected clinical user's account information, for example, editing a selected clinical users clinical username, passwords, and permission using fields such as: a clinical username field, an email address field, a last login date field, a date created field, an account approved field, a locked out field (indicative of the clinical user being locked out of the system), a date password changed field, a last lockout date field (the date the clinical user was last locked out of the system), a failed password count field (to collect the number of times a password can be attempted before an attempted user is locked out), and a failed password answer count field (to collect the number of times an answer to a password prompt is answered wrongly), and a comments field. As discussed previously for the login page, the account tab is modified when login data is not correct for a clinical user password, or a clinical user is otherwise locked out of the portal database. As one skilled in the art will appreciate, several drop down menus can be used for some of the data fields mentioned above, for example, embodiments of the invention may employ drop down menus for an institution name, a country selection, or a state selection under the address tab.

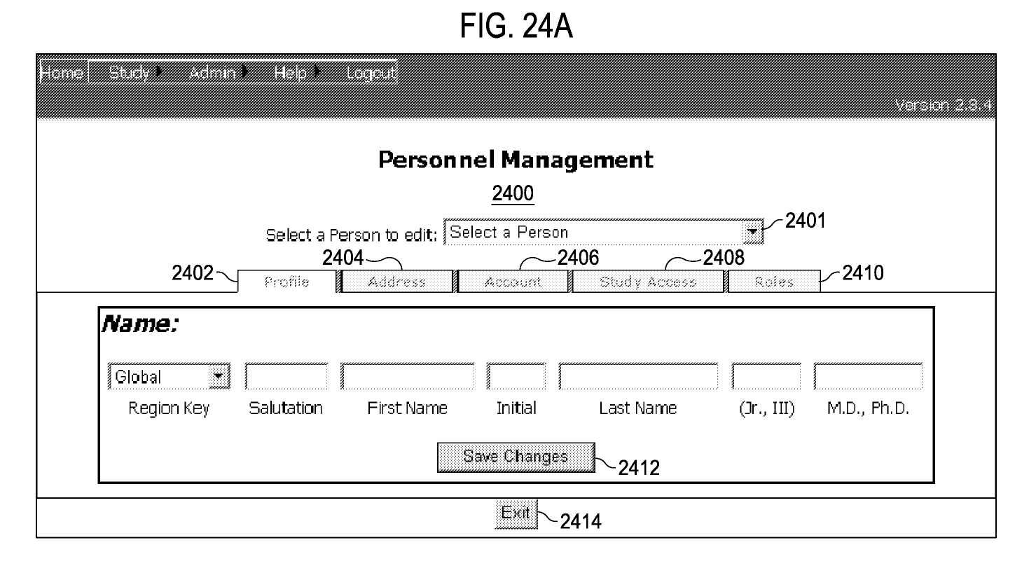

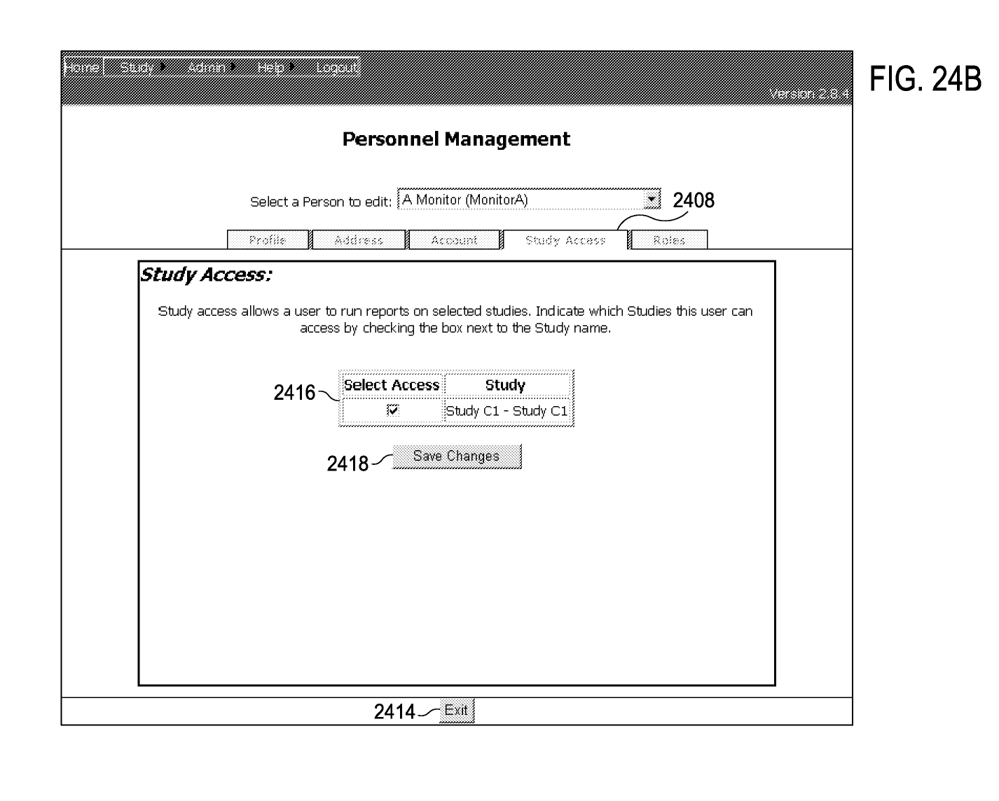

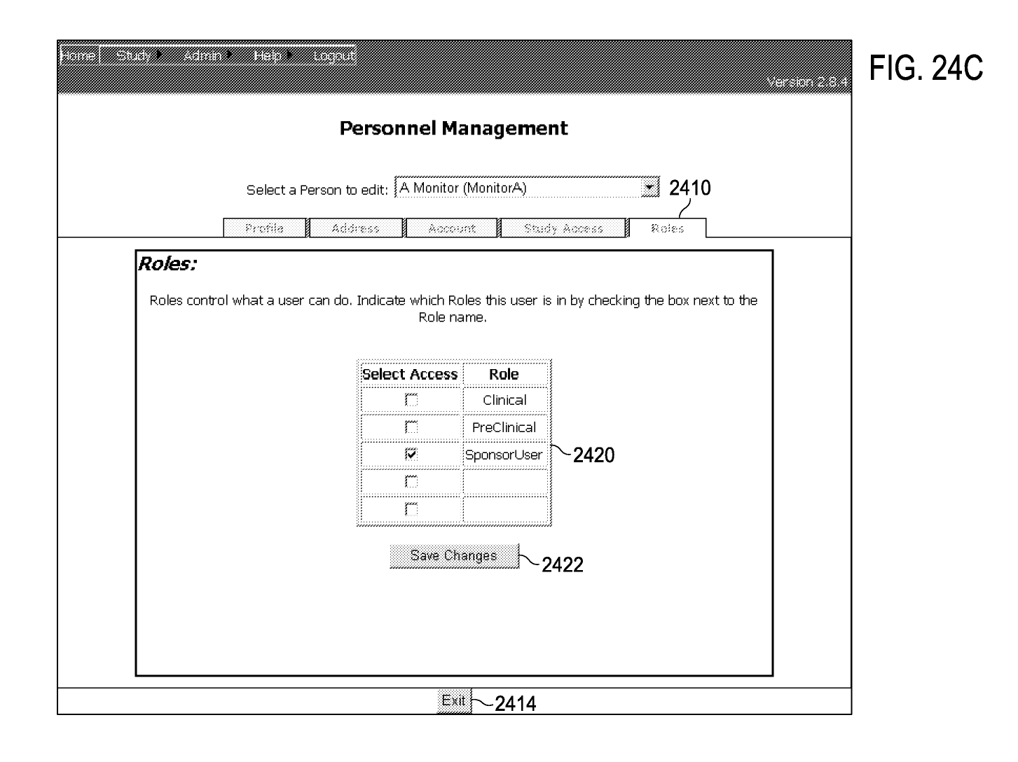

FIG. 24B is a computer display page having a clinical study access menu 2416 displayed thereon and initiated from the clinical study access tab 2408 selected from the personnel management menu 2400. The clinical study access menu allows the administrative clinical user to edit the clinical studies a clinical user can access according to an embodiment of the invention, and may include fields for selecting a clinical study from a plurality of studies associated with a clinical sponsor or research institution that can be associated with the clinical user. For example, the administrative user may associate a clinical sponsor contact with one study associated with the sponsor, but not other studies associated with the sponsor, or the administrative user may associate a clinical user, e.g., a lab technician, with a research institution to different studies associated with different sponsors that user is working with. Once the study is associated with a clinical user, the administrative user can save the data by selecting, e.g., the “save changes” tab 2418. As further shown in FIG. 24C, a clinical roles menu 2420 can be initiated when the roles tab 2410 is selected from the personnel management menu 2400. The clinical roles tab may be used to allow the administrative clinical user to edit a selected clinical user's access to clinical study data by the clinical user's role, e.g., whether the clinical user is a clinical user, pre-clinical user, sponsor clinical user. A clinical user is a START employee who may access all clinical studies. A preclinical user is a START employee who may access all preclinical studies. A sponsor user is a sponsor employee who may access only assigned studies conducted by that sponsor.

As one skilled in the art will appreciated, each of the fields described above for the personnel management menu 2400 may be populated by hand, e.g., typed, or selected by the administrative clinical user, or may be populated if an administrative clinical user selects a person to edit from the above described drop down menu. In this way, the personnel management menu 2400 allows an administrative clinical user to view and edit all data associated with a clinical user.

As one skilled in the art will also appreciate, using the plurality of wizards and fields described above, for a new clinical sponsor, the new clinical sponsor data, new clinical study data, and clinical patients and clinical users and permissions associated with the new clinical study must be entered into the system in logical order in some embodiments described above that use drop down menus. For example, the sponsor name drop down menu cannot be populated in the clinical study wizard 2100 until the clinical sponsor is entered into the database using the clinical sponsor wizard 2000. Moreover, though some embodiments may enable a user to enter new clinical sponsor and clinical study data into the system in any order, a specific data entry order may be required in some embodiments to created redundancy in the data entry portions of the portal database and thereby minimize data entry error and lost clinical data.

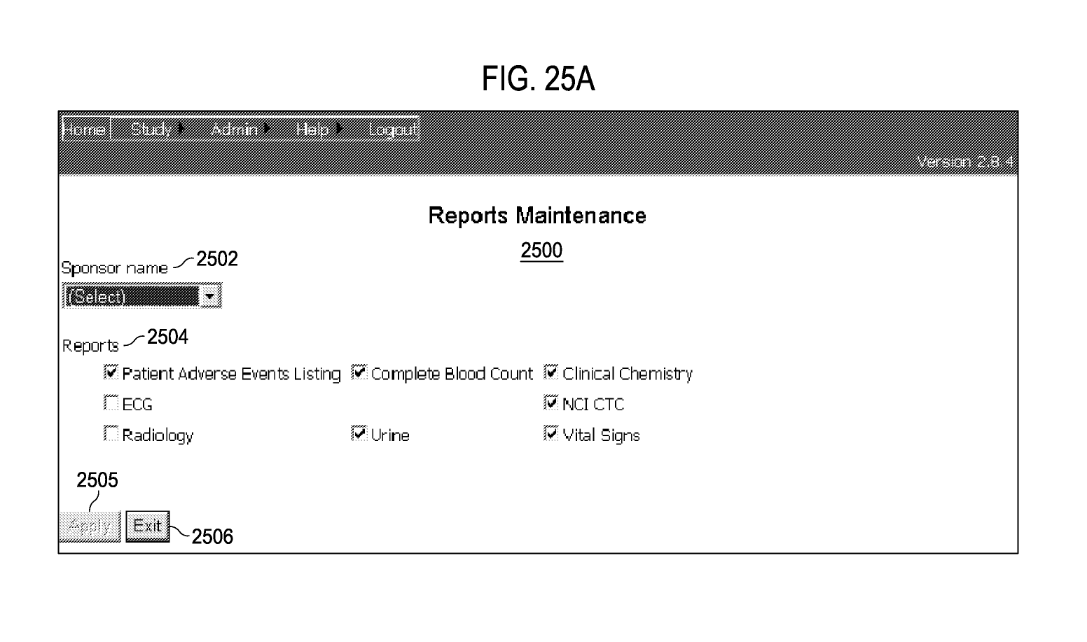

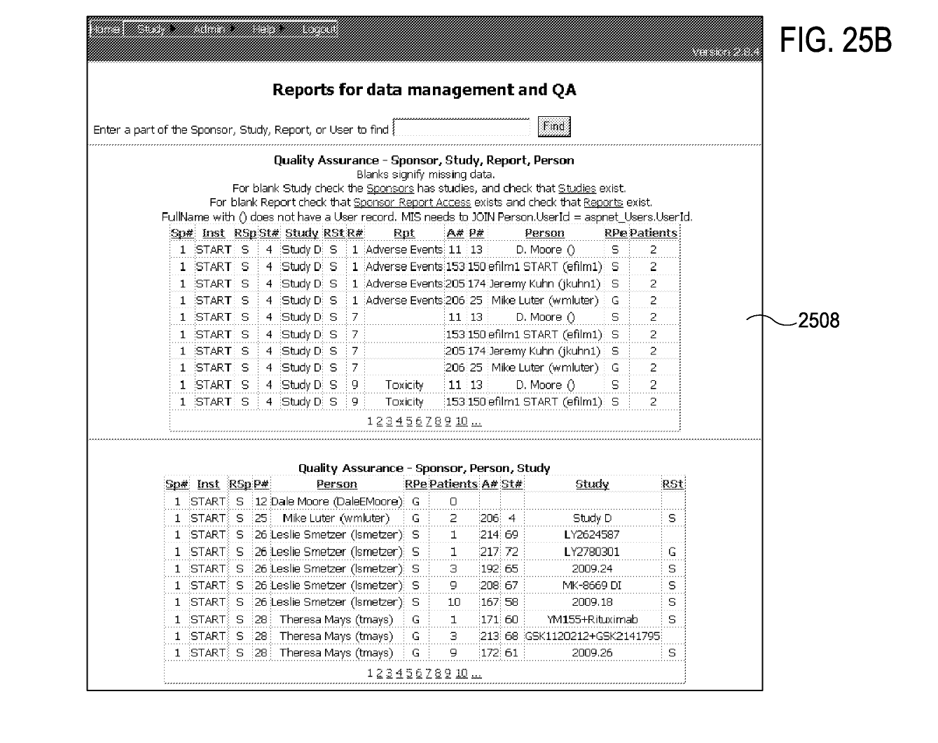

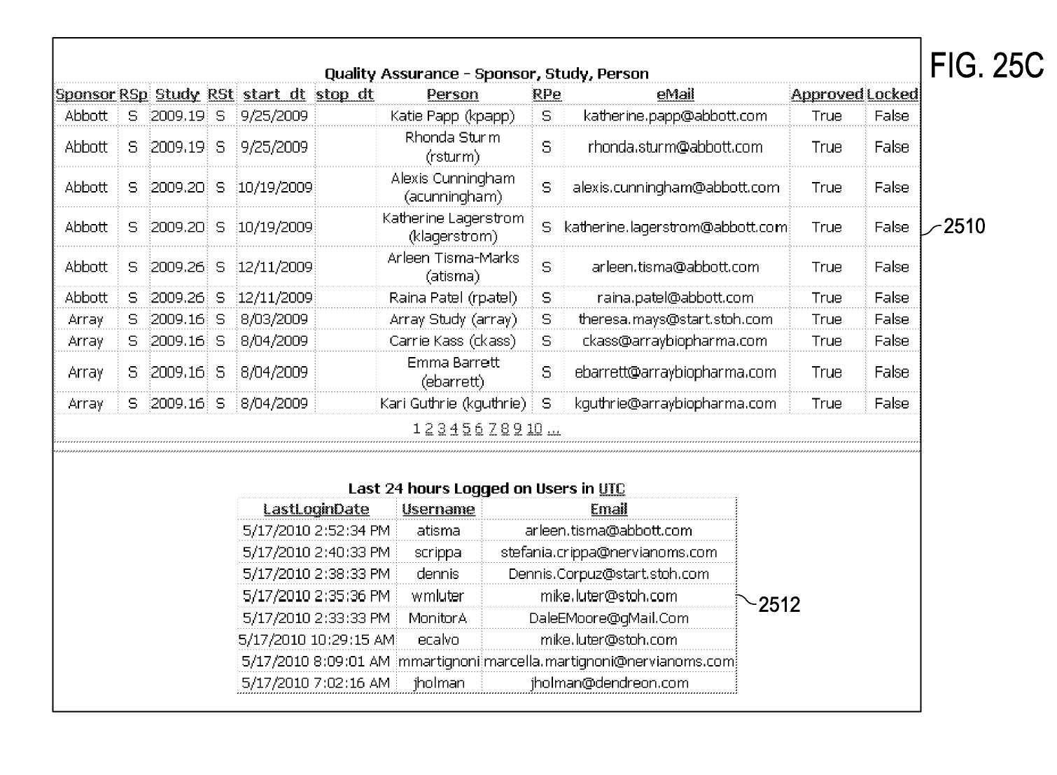

Returning to the administrative menu 804, upon the selection of “reports” under the drop down menu (FIG. 26), a clinical maintenance menu 2500 is initiated and associated reports 2508, 2510, and 2512 can be accessed as shown in FIGS. 25A-C. FIG. 25A is a computer display page having a clinical reports maintenance menu 2500 disposed thereon initiated upon the selection of “reports” from an administration menu 804 according to an embodiment of the invention. The clinical maintenance menu 2500 includes a clinical sponsor name select field 2502, and clinical reports selection menu 2504 associated with the particular clinical study and clinical sponsor names. The clinical reports selection menu 2504 can include reports for, e.g., patient adverse events listing, complete blood count, clinical chemistry, ECG, NCI CTC, radiology, urine, and vital signs. The clinical reports menu allows a clinical user to view the history of clinical reports downloaded to the portal database for data verification purposes. Accordingly, once the clinical user selects the reports to view, the clinical user selects the “apply” button 2505 to generate the reports or the “exit” button 2506 to exit the display screen. FIGS. 25B and 25C are report printouts showing down loaded data. For example, a download history for various clinical reports in the clinical reports maintenance menu may include all downloads for a patient adverse events listing, a CBC, clinical chemistry, urine, and vital signs downloaded for a particular sponsor. As can be seen, the quality assurance report includes a clinical sponsor number, an institution, where a clinical test report originated from, i.e., who downloaded the report, a clinical study identifier, a clinical test report name, a clinical patient study number, and a clinical patient EMR number. FIG. 25C is a computer display page of a download history 2510 for various clinical reports in the clinical reports maintenance menu according to an embodiment of the invention, i.e., a report of who downloaded study reports. The download history enables a clinical user to determine the person or people that have accessed a particular clinical study and the portal database. In this way, discrepancies in data, access breaches, etc., can be monitored and prevented by the system.

Returning to the administrative menu 804, the remaining selections, information 2605, password format 2606, and email users 2601 will be discussed with reference to FIG. 26. An information screen may be initiated upon the selection of the information 2605 from the administration menu 804 according to an embodiment of the invention. The information screen can be used to display a message to various other clinical users associated with the clinical study, for example, “new adverse events data has been uploaded”. Password format 2606 may be selected to generate a password log change form, which may be used by, e.g., the administrative clinical user, to change the password format from standard values to encrypted values. An email log 2600 may be initiated upon the selection of email 2601 from an administration menu 904 according to an embodiment of the invention. As discussed previously, the email log 2600 can be accessible by certain clinical users based upon permissions selected by the administrative clinical user. Using the email log 2600, clinical users can communicate with other clinical users associated with the study. For example, a clinical user associated with a sponsor may email a clinical user associated with the research institution regarding study data, study progress, etc. Or, researchers at various institutions may email each other regarding research studies conducted in various regions, e.g., a cancer study in the United States and Spain. In this way, the system creates an integrated portal for view and communicating with various stake holders in a research project.

Returning to FIG. 8, the remaining tabs on the home screen are the help tab and the log out tab. As one skilled in the art will appreciate, the help menu can include various text documents to aid in fixing common problems with the portal database, or providing instructions as to how to use the portal database, and system documentation, e.g., copyright notices, terms of use, etc. The clinical user selects the log out tab to log out of the portal database, though logging out of the system can be initiated by navigating away from the portal page, e.g., on the internet, or shutting off a computer in some embodiments.

As one skilled in the art will further appreciate, the display pages of FIGS. 6 through 26 are exemplary of the GUIs that may be initiated by the program product of the instant invention to perform the inventive functions herein. Other GUIs may be created that will help with efficiency of data entry, add additional test screens, or further organize patient, study and sponsor data, and accordingly not all embodiments of such GUIs have been described herein, but will be apparent to one of skill in the art. Accordingly, various GUIs may be used instead of or in addition to the display pages described herein, and the display pages are in no way to be considered limiting to the specification and claims, but are used for a descriptive sense only.

Moreover, in the drawings and specification, there have been disclosed a typical preferred embodiment of the invention, and although specific terms are employed, the terms are used in a descriptive sense only and not for purposes of limitation. The invention has been described in considerable detail with specific reference to these illustrated embodiments. It will be apparent, however, that various modifications and changes can be made within the spirit and scope of the invention as described in the foregoing specification, and such modifications and changes are to be considered equivalents and part of this disclosure.

This application is a continuation of and claims priority to U.S. Provisional Application 61/349,562 titled “Machine, Computer Program Product and Computer Implemented Method for Managing Clinical Research Data for a Plurality of Clinical Patients Participating in Clinical Drug Studies” filed on May 28, 2010, which is incorporated herein in its entirety.

1. A machine to enhance access to clinical research data collected in clinical drug research over a computer network, the machine characterized by:
one or more first databases storing a plurality of clinical patient exam records including a patient electronic medical record (EMR) identifier therein, the first database receiving input from a plurality of medical care providers, the input including clinical patient vital signs;
one or more second databases storing a plurality of clinical lab reports from a medical laboratory, the clinical lab reports including at least one of a patient EMR identifier, urine analysis, blood analysis, one or more chemical lab tests, and toxicity information;
one or more third databases storing radiological data received from a radiologist, the radiology data including one or more of a patient EMR identifier, magneto-resonance imaging (MRI) scan, computed tomography (CT) scans and positron emission tomography (PET) scans;
one or more fourth databases storing electrocardiogram (EKG) data received from a plurality of heart monitoring devices including an EKG machine; and
a computer connected to each of the first database, the second database, the third database and the fourth database and defining a portal database, the portal database having non-transitory computer memory with a computer program stored thereon and operable on the portal database, the computer program performing a process of organizing, compiling and hiding an identity of one or more clinical patients in the clinical research data and a process of allowing a plurality of clinical users to securely access the clinical research data through the portal database, the computer program executing instructions of:
assigning a plurality of clinical users permissions, the permissions including a first permission to add new data to the clinical research data, a second permission to view the clinical research data, a third permission to print the clinical research data, and a fourth permission to edit the clinical drug study tables, at least one of the clinical users being an administrative clinical user having the permission to add new data to the clinical research data,
populating a plurality of clinical study database tables by the administrative clinical user, the clinical study database tables including, a name of a clinical study sponsor; a clinical study identifier for a clinical drug study associated with the clinical sponsor, one or more clinical patient identifiers associated with the clinical drug study, and the plurality of clinical users associated with the clinical drug study and each users permissions,
relating at least one patient EMR identifier associated with a particular patient, selected from the one or more clinical patients, in one or more of the first database, second database, third database, and fourth database with a particular clinical patient identifier used by the portal database, selected from the one or more clinical patient identifiers and associated with the particular clinical patient,
polling one or more of the first database storing a plurality of clinical, second database, third database, and fourth database with the at least one patient EMR identifier in the portal database to populate a plurality of clinical patient tables for the particular patient with clinical research data, at least one of the clinical patient tables including the clinical study identifier, and
formatting the clinical research data for display to the one of the plurality of clinical users so that the identity of the particular clinical patient is hidden in the clinical research data.

2. A machine of claim 1, the computer program further executing instructions of:
relating one or more of the plurality of clinical study database tables with one or more of the plurality of clinical patient tables using the clinical patient identifier as a key, creating a record request prompt, responsive to one of the plurality of clinical users requesting access to the clinical drug study using the clinical study identifier, the record request prompt being organized by the one or more clinical patient identifiers and a clinical drug study enrollment date for each one or more clinical patients identified by the one or more clinical patient identifiers,
wherein the one or more clinical patient identifiers are created in a clinical patient add wizard, the clinical patient add wizard comprising prompts that allow the one of the plurality of clinical users to enter at least one of the particular clinical patient's electronic medical record number, the particular clinical patient's patient identifier, the clinical study identifier and the name of the clinical study sponsor.

3. A machine of claim 2, further executing the instructions of:
linking, responsive to the one of the plurality of clinical users requesting a particular clinical patient record associated with the particular clinical patient identifier on the record request prompt, the clinical research data for the particular clinical patient from the plurality of clinical patient tables so as to allow the one of the plurality of clinical users to view all available clinical research data related to the clinical drug study associated with the particular clinical patient identifier, the clinical research data being organized by record type for selection by the one of the plurality of clinical users,
wherein a permissions template to establish the first permission, second permission, third permission and fourth permission is generated by a personnel management wizard, the personnel management wizard being controlled by the administrative clinical user, the administrative clinical user being prompted to enter at least one of the following, a clinical user name, the clinical study sponsor, including a pharmaceutical company or outside service provider, associated with the clinical user name, an address of the clinical study sponsor, and a password and unique clinical user computer name associated with the clinical user name.

4. A machine of claim 3, wherein the personnel management wizard identifies each of the plurality of clinical users by each of the plurality of clinical users' role in the clinical drug study, the clinical users' role being selected from a group comprising study clinical user, pre-study clinical user, sponsor clinical user, administrator clinical user, and program clinical user.

5. A machine of claim 1, wherein one or more of a complete report of the clinical research data associated with the particular clinical patient is accessible by the one of the plurality of clinical users and particular clinical research data is accessible, and wherein the clinical research data includes a complete blood count, a clinical chemistry, a clinical patient report, a National Cancer Institute (NCI) Common Toxicity Criteria (CTC) report, a vital signs report, an adverse events report, a toxicity report and a urine report.

6. A machine of claim 5, wherein the computer program generates a quality assurance record for each clinical drug study, the quality assurance record including at least some data consisting of a research institution conducting the clinical drug study, a pharmaceutical company or outside service provider entering clinical research data into the database, the clinical drug study associated with the clinical research data uploaded, each of the plurality of the clinical users that entered the clinical research data, the number of particular clinical patients having clinical research data entered into the machine by any of the plurality of the clinical user in a particular session, each of the one or more clinical patient identifiers associated with any of the clinical research data accessed by any of the one or more clinical users, and the type of clinical research data entered.

7. A computer-implemented method to cause a computer defining a portal database to perform a process of organizing, compiling and hiding a clinical patient's identity in the clinical research data and a process of allowing a plurality of clinical users to securely access clinical research data through the portal database over a computer network, the computer-implemented method comprising:
assigning the plurality of clinical users permissions, the permissions including a first permission to add new data to the clinical research data, a second permission to view the clinical research data, a third permission to print the clinical research data, and a fourth permission to edit the clinical drug study tables, at least one of the clinical users being an administrative clinical user having the permission to add new data to the clinical research data;
populating a plurality of clinical study database tables by the administrative clinical user, the clinical study database tables including, a name of a clinical study sponsor; a clinical study identifier for a clinical drug study associated with the clinical sponsor, one or more clinical patient identifiers associated with the clinical drug study, and the plurality of clinical users associated with the clinical drug study and each users permissions;
relating at least one patient EMR identifier associated with a particular patient, selected from the one or more clinical patients, in one or more of the first database, second database, third database, and fourth database with a particular clinical patient identifier used by the portal database, selected from the one or more clinical patient identifiers and associated with the particular clinical patient;
polling one or more of a one or more of a first database storing a plurality of clinical patient exam records therein, the first database receiving input from a plurality of medical care providers, the input including clinical patient vital signs; a second database storing a plurality of clinical lab reports from a medical laboratory, the clinical lab reports including urine analysis, blood analysis, one or more chemical lab tests, and toxicity information, a third database storing radiological data received from a radiologist, the radiology data including one or more MRIs, CT scans and PET scans; and a fourth database storing EKG data received from a plurality of heart monitoring devices including an EKG machine with the at least one patient EMR identifier in the portal database to populate a plurality of clinical patient tables for the particular patient with clinical research data, at least one of the clinical patient tables including the clinical study identifier; and
formatting the clinical research data for display to the one of the plurality of clinical users, responsive to input from the clinical user so that the identity of the particular clinical patient, including the patient EMR identifier, is hidden in the clinical research data and only the clinical patient identifier can be viewed.

8. A computer-implemented method of claim 7, further comprising:
relating one or more of the plurality of clinical study database tables with one or more of the plurality of clinical patient tables using the clinical patient identifier as a key, creating a record request prompt, responsive to one of the plurality of clinical users requesting access to the clinical drug study using the clinical study identifier, the record request prompt being organized by the one or more clinical patient identifiers and a clinical drug study enrollment date for each one or more clinical patients identified by the one or more clinical patient identifiers,
wherein the one or more clinical patient identifiers are created in a clinical patient add wizard, the clinical patient add wizard comprising prompts that allow the one of the plurality of clinical users to enter at least one of the particular clinical patient's electronic medical record number, the particular clinical patient's patient identifier, the clinical study identifier and the name of the clinical study sponsor.

9. A computer-implemented method of claim 7, further comprising:
linking, responsive to the one of the plurality of clinical users requesting a particular clinical patient record associated with the particular clinical patient identifier on the record request prompt, the clinical research data for the particular clinical patient from the plurality of clinical patient tables so as to allow the one of the plurality of clinical users to view all available clinical research data related to the clinical drug study associated with the particular clinical patient identifier, the clinical research data being organized by record type for selection by the one of the plurality of clinical users,
wherein a permissions template to establish the first permission, second permission, third permission and fourth permission is generated by a personnel management wizard, the personnel management wizard being controlled by the administrative clinical user, the administrative clinical user being prompted to enter at least one of the following, a clinical user name, the clinical study sponsor, including a pharmaceutical company or outside service provider, associated with the clinical user name, an address of the clinical study sponsor, and a password and unique clinical user computer name associated with the clinical user name.

10. A computer-implemented method of claim 9, wherein the personnel management wizard identifies each of the plurality of clinical users by each of the plurality of clinical users' role in the clinical drug study, each of the clinical users' role being selected from a group comprising study clinical user, pre-study clinical user, sponsor clinical user, administrator clinical user, and program clinical user.

11. A computer-implemented method of claim 7, wherein one or more of a complete report of the clinical research data associated with the particular clinical patient is accessible by the one of the plurality of clinical users and particular clinical research data is accessible, and wherein the clinical research data includes a complete blood count, a clinical chemistry, a clinical patient report, a NCI CTC report, a vital signs report, an adverse events report, a toxicity report and a urine report.

12. A computer-implemented method of claim 7, further comprising:
generating a quality assurance record for each clinical drug study, the quality assurance record including at least some data consisting of a research institution conducting the clinical drug study, pharmaceutical company or outside service provider entering clinical research data into the database, the clinical drug study associated with the clinical research data uploaded, each of the plurality of the clinical users that entered the clinical research data, the number of particular clinical patients having clinical research data entered into the machine by any of the plurality of the clinical users in a particular session, each of the one or more clinical patient identifiers associated with any of the clinical research data accessed by any of the plurality of clinical users, and the type of clinical research data entered.

13. A computer-implemented method of claim 12, wherein the quality assurance prompt includes a listing of the most active of the plurality of clinical users of the computer-implemented method for a particular clinical study in a particular time period.

14. A non-transitory computer readable storage medium having program instruction stored thereon that are executable by a processor to cause the following steps to cause a computer defining a portal database to a process of organizing, compiling and hiding a clinical patient's identity in the clinical research data and a process of allowing a plurality of clinical users to securely access clinical research data through the portal database over a computer network:
assigning the plurality of clinical users permissions, the permissions including a first permission to add new data to the clinical research data, a second permission to view the clinical research data, a third permission to print the clinical research data, and a fourth permission to edit the clinical drug study tables, at least one of the clinical users being an administrative clinical user having the permission to add new data to the clinical research data;
populating a plurality of clinical study database tables by the administrative clinical user, the clinical study database tables including, a name of a clinical study sponsor; a clinical study identifier for a clinical drug study associated with the clinical sponsor, one or more clinical patient identifiers associated with the clinical drug study, and the plurality of clinical users associated with the clinical drug study and each users permissions;
relating at least one patient EMR identifier associated with a particular patient, selected from the one or more clinical patients, in one or more of the first database, second database, third database, and fourth database with a particular clinical patient identifier used by the portal database, selected from the one or more clinical patient identifiers and associated with the particular clinical patient;
polling one or more of a one or more of a first database storing a plurality of clinical patient exam records therein, the first database receiving input from a plurality of medical care providers, the input including clinical patient vital signs; a second database storing a plurality of clinical lab reports from a medical laboratory, the clinical lab reports including urine analysis, blood analysis, one or more chemical lab tests, and toxicity information, a third database storing radiological data received from a radiologist, the radiology data including one or more MRIs, CT scans and PET scans; and a fourth database storing EKG data received from a plurality of heart monitoring devices including an EKG machine with the at least one patient EMR identifier in the portal database to populate a plurality of clinical patient tables for the particular patient with clinical research data, at least one of the clinical patient tables including the clinical study identifier; and
formatting the clinical research data for display to the one of the plurality of clinical users, responsive to input from the clinical user so that the identity of the particular clinical patient, including the patient EMR identifier, is hidden in the clinical research data and only the clinical patient identifier can be viewed.

15. A medium as defined in claim 14, the steps further comprising:
relating one or more of the plurality of clinical study database tables with one or more of the plurality of clinical patient tables using the clinical patient identifier as a key, creating a record request prompt, responsive to one of the plurality of clinical users requesting access to the clinical drug study using the clinical study identifier, the record request prompt being organized more clinical patient identifiers and a clinical drug study enrollment date for each one or more clinical patients identified by the one or more clinical patient identifiers,
wherein the one or more clinical patient identifiers are created in a clinical patient add wizard, the clinical patient add wizard comprising prompts that allow the one of the plurality of clinical users to enter at least one of the particular clinical patient's electronic medical record number, the particular clinical patient's patient identifier, the clinical study identifier and the name of the clinical study sponsor.

16. A medium as defined in claim 14, the steps further comprising:
linking, responsive to the one of the plurality of clinical users requesting a particular clinical patient record associated with the particular clinical patient identifier on the record request prompt, the clinical research data for the particular clinical patient from the plurality of clinical patient tables so as to allow the one of the plurality of clinical users to view all available clinical research data related to the clinical drug study associated with the particular clinical patient identifier, the clinical research data being organized by record type for selection by the one of the plurality of clinical users,
wherein a permissions template to establish the first permission, second permission, third permission and fourth permission is generated by a personnel management wizard, the personnel management wizard being controlled by the administrative clinical user, the administrative clinical user being prompted to enter at least one of the following, a clinical user name, the clinical study sponsor, including a pharmaceutical company or outside service provider, associated with the clinical user name, an address of the clinical study sponsor, and a password and unique clinical user computer name associated with the clinical user name.

17. A medium as defined in claim 14, wherein the personnel management wizard identifies each of the plurality of clinical users by each of the plurality of clinical users' role in the clinical drug study, each of the clinical users' role being selected from a group comprising study clinical user, pre-study clinical user, sponsor clinical user, administrator clinical user, and program clinical user.

18. A medium as defined in claim 14, wherein one or more of a complete report of the clinical research data associated with the particular clinical patient is accessible by the one of the plurality of clinical users and particular clinical research data is accessible, and wherein the clinical research data includes a complete blood count, a clinical chemistry, a clinical patient report, a NCI CTC report, a vital signs report, an adverse events report, a toxicity report and a urine report.

19. A medium as defined in claim 14, the steps further comprising:
generating a quality assurance record for each clinical drug study, the quality assurance record including at least some data consisting of a research institution conducting the clinical drug study, pharmaceutical company or outside service provider entering clinical research data into the database, the clinical drug study associated with the clinical research data uploaded, each of the plurality of the clinical users that entered the clinical research data, the number of particular clinical patients having clinical research data entered into the machine by any of the plurality of the clinical users in a particular session, each of the one or more clinical patient identifiers associated with any of the clinical research data accessed by any of the plurality of clinical users, and the type of clinical research data entered.

20. A medium as defined in claim 14, wherein the quality assurance prompt includes a listing of the most active of the plurality of clinical users of the computer-implemented method for a particular clinical study in a particular time period.
